(19) United States
(12) Patent Application Publication
(10) Pub. No.: US 2009/0265459 A1
(43) Pub. Date: Oct. 22, 2009

(54) PROVIDING APPARATUS OF SERVICE INFORMATION AND PROVIDING METHOD THEREOF

(75) Inventors: Kenji Hikichi, Kawasaki (JP); Akiko Yamada, Kawasaki (JP); Shunsuke Kikuchi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/339,427

(22) Filed: Dec. 19, 2008

(30) Foreign Application Priority Data
Apr. 16, 2008 (JP) 2008-107269

(51) Int. Cl. G06F 15/173

(52) U.S. Cl. 709/224

(57) ABSTRACT

A providing apparatus of service information provided over a network collects service information and/or service components provided over a network and is triggered by setting of a scenario (such as content such as a combination of service components or service information) to extract available service components for the scenario from the service information or the service components to generate integrated service information with the use of the service components based on the scenario. A scenario and a policy (selection criteria of service components) are set and the service components conforming to the policy are selected to create the integrated service information based on the scenario.

### CROSS-REFERENCE TO RELATED APPLICATIONS

This application is based upon and claims the benefit of priority from the prior Japanese Patent Application No. 2008-107269, filed on Apr. 16, 2008, the entire contents of which are incorporated herein by reference.

### FIELD

Present embodiments relate to a service information integrating process under an environment where service information such as service components (e.g., Web services) is provided over a network such as a wide area network (e.g., wide area SOA: Service Oriented Architecture environment) and, more particularly, to a providing apparatus of service information, a providing method thereof, and a providing program thereof that integrate service information or service components with the use of scenarios and policies.

### BACKGROUND

Numerous wide-ranging pieces of service information are provided over networks and many pieces thereof are published. For users utilizing network services, it is useful to utilize these pieces of service information. For providers of network services, providing the service information is useful and increasingly becomes indispensable.

With regard to the utilization of service information published on a network, Japanese Patent Application Laid-Open Publication No. 2004-21873 discloses that operation of the whole environment capable of providing various services spread over a plurality of systems via the Internet is monitored by registering a domain and service providing procedures of the monitoring object service in an alternative server and creating a user for monitoring (abstract, FIG. 1, etc.). In this operation monitoring, collation of data is carried out between the monitoring object service and the alternative server to monitor fraudulent data interpolation, and at the same time, the service is provided by the alternative server when there is trouble in the monitoring object service. Therefore, downtime of the service due to the trouble is shortened, and the system and service with high safety and availability is provided to the service user.

If the technique disclosed in Japanese Patent Application Laid-Open Publication No. 2004-21873 is used in regard to the utilization of service information published on a network, although stable services may be configured from the viewpoint of system availability, required or optimum service information for users may not necessarily be provided under the environment where numerous service components are provided over a network. It is difficult to make a selection based on various selection criteria such as costs of service components, user's preferences, and trends.

With regard to such utilization of service information, the service components are affected by environmental variations such as network and server operation states of the information sources (such as business organizations), service quality, and evaluations from users, which causes utilized service components to be varied or biased.

In such cases that several service components having equivalent functions are provided from a plurality of information sources (such as business organizations) and that service components having different qualities of the same type are provided from a single information source, one of the service components must be selected. However, as described above, it is not easy to determine which service component is optimum and select a suitable service component while giving consideration to environmental variations, etc.

Japanese Patent Application Laid-Open Publication No. 2004-21873 does not disclose or suggest these requirements and problems as well as a configuration, etc., for resolving the requirements and the problems.

### SUMMARY

Aspects of embodiments of the present invention provide a service information providing apparatus, a providing method thereof, and a providing program thereof, which collect service information and/or service components provided over a network, and are triggered by setting of a scenario (such as content such as a combination of service components or service information) to extract available service components for the scenario from the service information or the service components to generate integrated service information with the use of the service components based on the scenario. A scenario and a policy (selection criteria of service components) are set and the service components conforming to the policy are selected to create the integrated service information based on the scenario. With such a configuration, the integrated service information of the service components based on the scenario may be generated based on the extraction of the service components necessary for the scenario from the service information, or the integrated service information based on the scenario may be generated based on the selection of the service components conforming to the policy from the extracted service information, to achieve improvement in the convenience of the service information, generation of the integrated service information corresponding to environmental variations, and the improvement in the stability of provision of the integrated service information.

According to an aspect of embodiments of the invention, a service information providing apparatus includes a collecting part that collects service information and/or service components provided over a network; an extracting part that extracts service components to be used for a set scenario from the service information or the service components based on the scenario; and a generating part that generates integrated service information based on the scenario with the use of the service components extracted by the extracting part.

With such a configuration, since the service information and/or service components provided over a network are collected and service components used for a scenario are extracted from the service information or the service components based on the scenario to generate the integrated service information with the use of the service components, available information may be processed to provide the integrated service information as highly-convenient and highly-stable service information.

According to an another aspect of the embodiments of the invention, a service information providing method includes collecting service information and/or service components provided over a network; extracting service components to be used for a set scenario from the service information or the service components based on the scenario; and generating integrated service information based on the scenario with the use of the service components extracted at the above step.

Objects and advantages of the embodiments of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features, and advantages of the embodiments will become more apparent by reference to the accompanying drawings and embodiments.

### BRIEF DESCRIPTION OF DRAWINGS

FIG. 1 is a diagram of a service information providing system according to a first embodiment;

FIG. 2 is a flowchart of a process procedure of integrated service information;

FIG. 3 is a flowchart of a determining process of a cost path through scenarios and policies;

FIG. 4 is a diagram of a relationship among service components, scenarios, policies, and the integrated service information;

FIGS. 5A and 5B are diagrams of a scenario and service components;

FIG. 6 is a diagram of retrieval of service component candidates;

FIG. 7 is a diagram of retrieval of service component candidates;

FIG. 8 is a diagram of a service configuration over networks;

FIG. 9 is a diagram of scenarios of ski tour plan support service information;

FIG. 10 is a diagram of policies of ski tour plan support service information;

FIG. 11 is a diagram of provider information;

FIG. 12 is a diagram of service information/passing path information;

FIG. 13 is a diagram of the integrated service information;

FIG. 14 is a flowchart of a process procedure of the integrated service information;

FIG. 15 is a flowchart of a process procedure of the integrated service information;

FIG. 16 is a diagram of a service configuration;

FIG. 17 is a diagram of a policy;

FIG. 18 is a diagram of a service configuration;

FIG. 19 is a flowchart of a process procedure of an integrating process due to addition of a policy;

FIG. 20 is a diagram of a policy;

FIG. 21 is a diagram of a service configuration;

FIG. 22 is a flowchart of a process procedure of dynamic modification of scenarios;

FIG. 23 is a diagram of service information/passing path information;

FIG. 24 is a diagram of a service configuration;

FIG. 25 is a diagram of a change in the integrated service information;

FIG. 26 is a flowchart of a process procedure of detection of a change in the network state;

FIG. 27 is a flowchart of a process procedure of the integrated service information;

FIG. 28 is a diagram of a policy;

FIG. 29 is a diagram of service information/passing path information;

FIG. 30 is a diagram of a service configuration;

FIG. 31 is a diagram of an exemplary configuration of an integrated service deciding function unit;

FIG. 32 is a diagram of a service information providing system according to a second embodiment;

FIG. 33 is a diagram of an access sequence of the integrated service information;

FIG. 34 is a diagram of a service information providing system according to a third embodiment;

FIG. 35 is a diagram of a network system according to a fourth embodiment; and

FIG. 36 is a diagram of a server used for a service information providing system according to a fifth embodiment;

### DESCRIPTION OF EMBODIMENTS

### First Embodiment

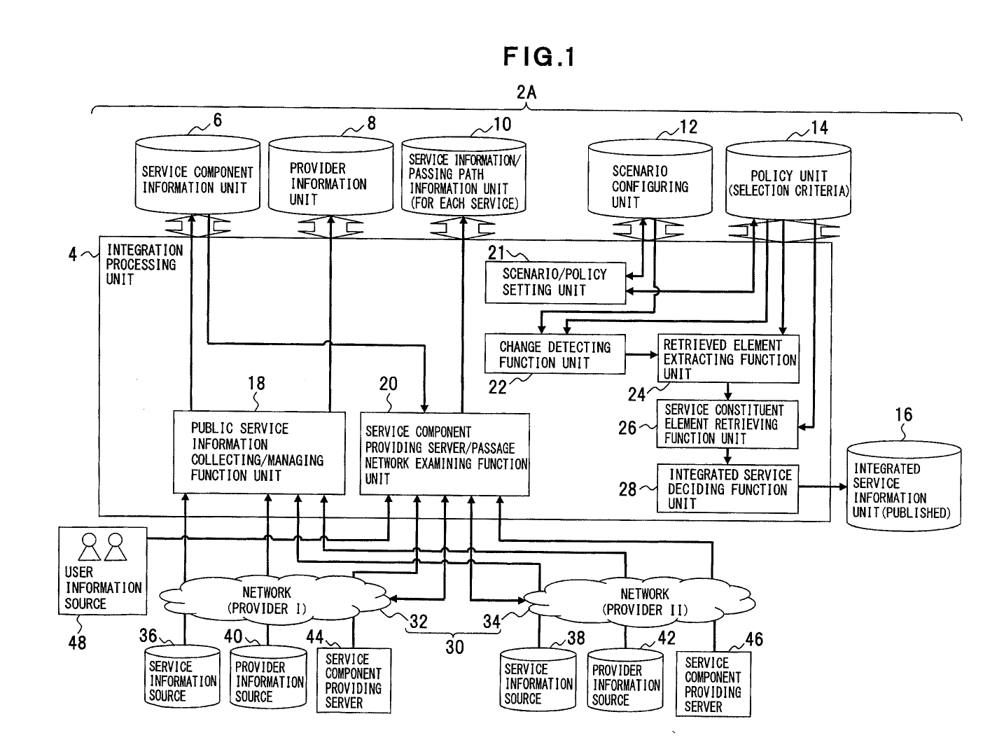

A first embodiment will be described with reference to FIG. 1. FIG. 1 depicts a service information providing system. A configuration depicted in FIG. 1 is by way of example and the present invention is not limited to this configuration.

A service information providing system 2A is an example of a providing apparatus of service information, a providing method thereof, and a providing program thereof, is a system collecting service information provided over a network, extracting service components from the service information, and combining the service components to generate integrated service information with the use of a computer, and includes an integration processing unit 4, a service component information unit 6, a provider information unit 8, a service information/passing path information unit 10, a scenario configuring unit 12, a policy unit 14, and an integrated service information unit 16 to implement the above processes, as depicted in FIG. 1.

The service information for the service information providing system 2A is any information provided over networks. A service component is information such as partial information of the service information or the service information itself. Integrated service information is generated by combination of service components (including service component groups) and is generated with the use of different parameters called scenarios and policies (selection criteria). A scenario is content such as a combination of two or more service components, and a policy is a multifaceted aspect such as stability, quality, quantity, and value of a multiplicity of service components or a service component group and is a selection criterion for extracting service components.

The integration processing unit 4 is an information processing means made up of a computer, is a processing means collecting public service information over networks, extracting service components conforming to the policies from service information, combining the service components in accordance with the scenarios, and executing a process of generating integrated service information made up of a plurality of service components, and includes a public service information collecting/managing function unit 18, a service component providing server/passage network examining function unit 20, a scenario/policy setting unit 21, a change detecting function unit 22, a retrieved element extracting function unit 24, a service constituent element retrieving function unit 26, and an integrated service deciding function unit 28 in this embodiment.

The public service information collecting/managing function unit 18 is an information collecting and managing means that collects and manages various types of information published over networks 30, collects information such as which service component is provided in what location over networks 32 and 34 as the service information to make the information available when configuring the integrated service information, and records information such as through which network provider the services are provided (service component information). The service component information includes provider information, and the provider information is information of a service (e.g., bandwidth assurance and delay assurance) provided by a network provider.

For example, the public service information collecting/managing function unit 18 is connected to a network provider I through the network 32 and to a network provider II through the network 34 and is provided with a plurality of pieces of the service information published over the networks 30 from service information sources 36 and 38 and with information of the network providers from provider information sources 40 and 42.

The service component information collected by the public service information collecting/managing function unit 18 is stored in the service component information unit 6 and the provider information is stored in the provider information unit 8. The service component information unit 6 is a recording means of the service component information and makes up a database thereof, and the provider information unit 8 is a recording means of the provider information and makes up a database thereof. Management such as recording and updating of the service component information and the provider information is performed by the public service information collecting/managing function unit 18.

The service component providing server/passage network examining function unit 20 is a means of examination, information collection, recording, and information management of service component providing servers 44 and 46 connected to the networks 30 and a passage network as well as a measuring/evaluating means that periodically examines stability of the service information sources (servers) and the networks and periodically examines and records various pieces of information such as information representing states of servers providing the service components and the passage networks 32 and 34 thereof (service information/passing path information) for each service component or each service information including the service component. The service component providing servers 44 and 46 are service information sources providing the service information such as service components. Information such as word-of-mouth information from a user information source 48 may be incorporated as an information source other than the networks 32 and 34. The information such as the service information and the passing path information (passage network information) is stored in the service information/passing path information unit 10. The service information/passing path information unit 10 is a recording means for information related to service providing environments and makes up a database thereof. Management such as recording and updating of the service information and the passing path information is performed by the service component providing server/passage network examining function unit 20. These pieces of information related to the service providing environment are utilizes as information for configuring the integrated service

Scenarios and policies (selection criteria) used for integrating the service components are set and these scenarios and policies are defined, added, or modified by an integrated service company that manages the integration processing unit 4. The scenarios are stored in the scenario configuring unit 12 and the policies are stored in the policy unit 14. The scenario configuring unit 12 is a recording means that has the scenarios stored thereon and makes up a database of the scenarios. The policy unit 14 is a recording means that has stored thereon the policies constituting the selection criteria of the service components and makes up a database of the policies.

The scenario/policy setting unit 21 is a setting means of the above scenarios and/or policies, and scenarios or policies, or, scenarios and policies are set by an administrator such as a company operating an integrated service company server. This setting is executed with the use of a displaying means that displays a setup screen for scenarios and/or policies and an input means such as a keyboard.

The change detecting function unit 22 is a means of dynamically detecting changes in scenarios and policies, detects addition and modification of scenarios, and notifies the retrieved element extracting function unit 24 of detection information of added/modified scenarios and policies.

The retrieved element extracting function unit 24 is an extracting means that extracts the service components conforming to the policies from the service information collected by the public service information collecting/managing function unit 18 and extracts candidates of the service component that may serve as a constituent element from the service information and the service component information based on the scenarios. With regard to the extraction of the service information, if service components having the same service contents are provided from different service information sources (service companies), all these service components are extracted since these service components are handled as a plurality of candidates.

The service constituent element retrieving function unit 26 is an integrated service information generating means that generates the integrated service information by combining the service components conforming to the policies in accordance with the scenarios with the use of stability information of servers and networks and determines which is used among the service components extracted based on the policies in the policy unit 14. At the time of the determination, the optimum service component conforming to a policy may be selected by using not only the service component information and the provider information but also the environment information such as the service information/passing path information. If two or more different policies are set, the same integrated services may be generated from different service components.

The integrated service deciding function unit 28 is a means of deciding the integrated service information conforming to the policies and includes a warning means that gives warning if information does not conform to the policies. The integrated service deciding function unit 28 decides the integrated service information made up of the service components determined by the service constituent element retrieving function unit 26 and the publication thereof and gives warning and notification of integrated service information not conforming to the policies if the warning means is included.

The integrated service information unit 16 is a publishing means of the integrated service information and receives the provision of the integrated service information decided by the integrated service deciding function unit 28 to publish for making the integrated service information actually available to users.

According to the service information providing system 2A as above, with regard to one piece of integrated service information, the integrated service information may be generated from service components conforming to a single policy or variations of the integrated service information may be created from different service components for each of a plurality of different policies, and these pieces of the information may be published and provided. Since users may select desired integrated service information with policies, the convenience of the service information is improved, and necessary service information may be acquired as integrated service information.

Since the change detecting function unit 22 may detect that a scenario is added/modified or that a policy is added/modified in the service information providing system 2A, the integrated service information conforming to the added/modified scenario or policy may rapidly be provided.

The integrated service companies using the service information providing system 2A may rapidly publish new integrated service information by only adding or modifying scenarios or policies or may rapidly and timely perform modification of configuration of the published integrated service information, which improves the convenience of provision of the service information to users.

Since the change detecting function unit 22 monitors and detects changes in the service information/passing path information, the integrated service information may be reconfigured, updated, and published in similar procedures. Therefore, if environmental information such as status of the service component providing server or network is varied from the time point when the integrated service information is configured, scenarios created for respective policies may rapidly be modified to optimum configurations and the modification may be accelerated.

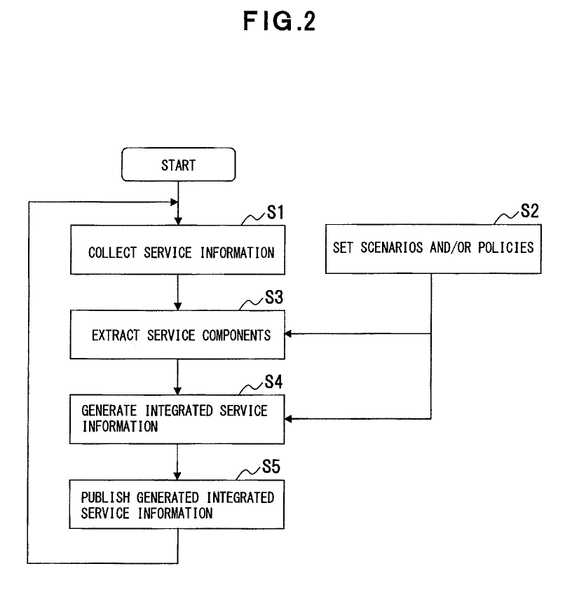

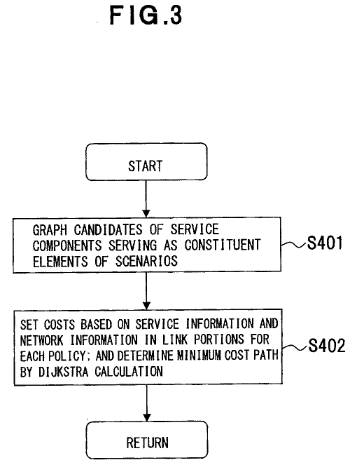

Processes for the integrated service information will then be described with reference to FIGS. 2 and 3. FIG. 2 is a flowchart of a process procedure of the integrated service information and FIG. 3 is a flowchart of a determining process of a cost path through scenarios and policies. Configurations depicted in FIGS. 2 and 3 are by way of example and the present invention is not limited to these configurations.

In this process procedure, service information is collected as depicted in FIG. 2 (step S1). The collection of the service information is performed for numerous pieces of service information published over the networks 30, and the collected service information and/or service components are stored in the service component information unit 6.

Setting of scenarios and/or policies is performed (step 2). This setting of the scenarios and/or policies is set by an administrator such as a company operating the integrated service company server. The scenarios are stored in the scenario configuring unit 12 and the policies are stored in the policy unit 14. The scenarios and the policies are used in the extraction of the service components (step S3) and the generation of the integrated service information (step S4).

In the extraction of the service components, the service components necessary for the scenarios are extracted from the collected service information, and in the generation of the integrated service information, the integrated service information is generated using the service components selected based on the policies from the extracted service components. In the generation of the integrated service information, changes in the scenarios and the policies are always monitored and the integrated service information is modified and regenerated based on the changed scenarios and policies.

The generated integrated service information is published over the networks after checking whether the information matches with the set scenarios and policies (step S5). If the generated integrated service information does not match with the scenarios and the policies, a notification of this fact is made to prompt regeneration.

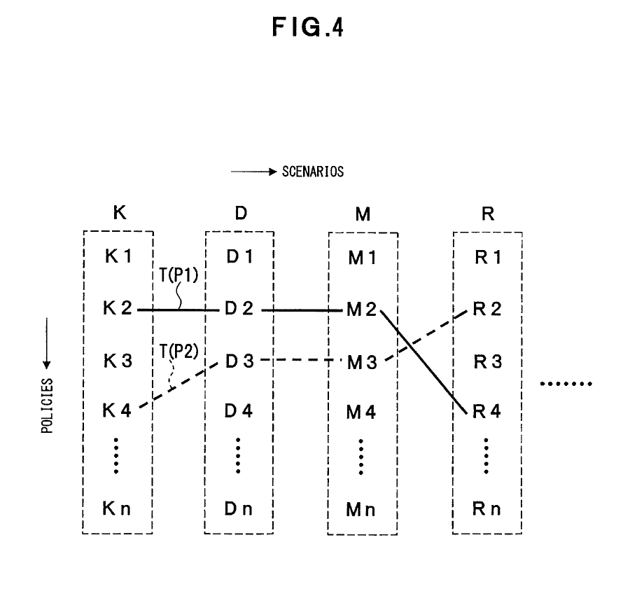

In the generation process of the integrated service information, as depicted in FIG. 3, candidates of the service components serving as constituent elements of the scenarios are extracted and graphed (step S401); costs based on the service information and the network information are set in link portions on the graph for each policy; and a minimum cost path is determined by, for example, a series of calculation processes for obtaining the optimum path such as the Dijkstra's algorithm (hereinafter, Dijkstra calculation) (step S402). As a result, the minimum cost is obtained and the integrated service information is generated with the policy defined as the minimum cost. After this process, the procedure goes back to step S4 (FIG. 4).

The integrated service information will be described with reference to FIG. 4. FIG. 4 depicts a relationship among service components, scenarios, policies, and the integrated service information. A configuration depicted in FIG. 4 is by way of example and the present invention is not limited to this configuration.

Service components K, D, M, R . . . are combined in accordance with scenarios, and certain service components are selected in accordance with policies from service components K1, K2, K3 . . . Kn, D1, D2, D3 . . . Dn, M1, M2, M3 . . . Mn, R1, R2, R3 . . . Rn.

If the service components K2, D2, M2, and R4 are selected based on a policy P1 and the service components K4, D3, M3, and R2 are selected based on a policy P2, integrated service information T(P1) based on the policy P1 is configured as follows.

T(P1)={K2,D2,M2,R4} (1)

Integrated service information T(P2) based on the policy P2 is configured as follows.

T(P2)={K4,D3,M3,R2} (2)

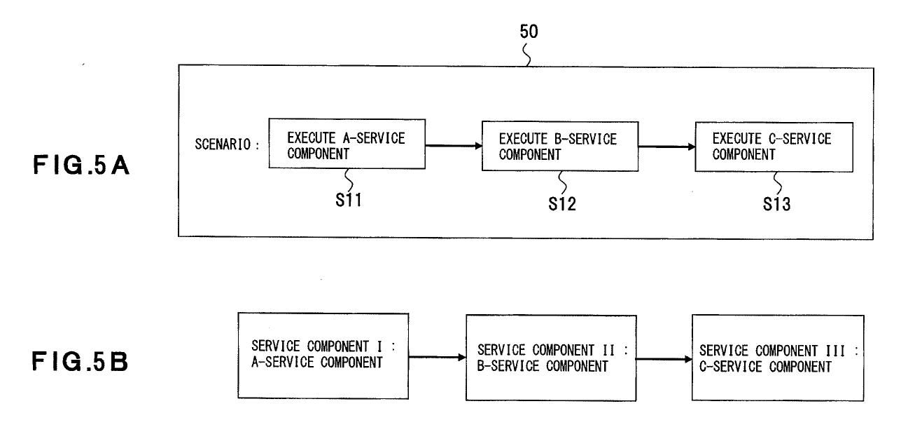

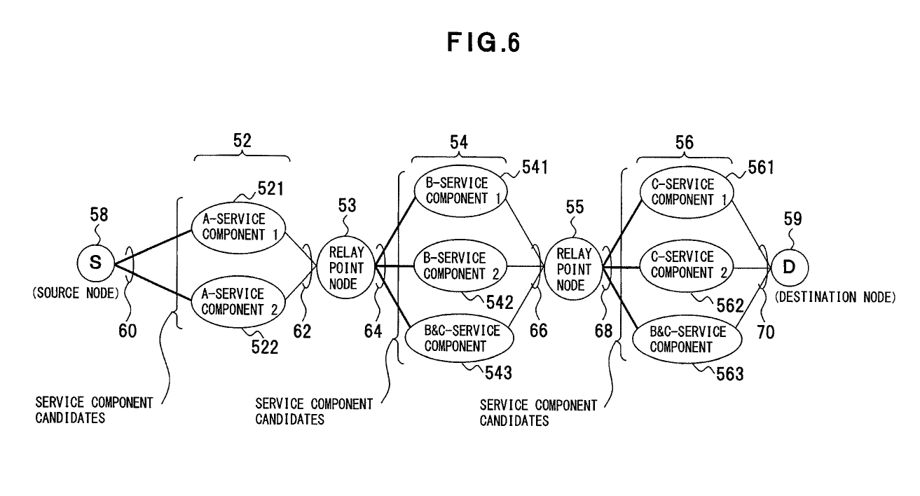

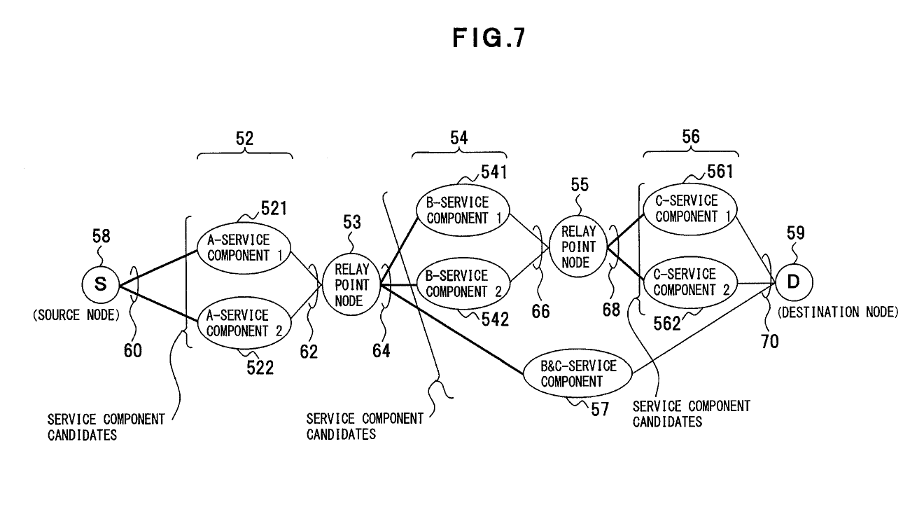

Retrieval of the service components will be described with reference to FIGS. 5A, 5B, 6, and 7. FIGS. 5A and 5B depict a scenario and the service components and FIGS. 6 and 7 depict retrieval of service component candidates. Configurations depicted in FIGS. 5 to 7 are by way of example and the present invention is not limited to these configurations.

The retrieval process of the service components is a process procedure of determining a configuration of the optimum service components and is implemented by a retrieving function of the service constituent element retrieving function unit 26. A scenario 50 is set in this retrieval of the service components, and the scenario 50 sets an order of execution of an A-service component (step S11), execution of a B-service component (step S12), and execution of a C-service component (step S13), as depicted in FIG. 5A. The scenario 50 defines that a service component I: the A-service component, a service component II: the B-service component, and a service component III: the C-service component, as depicted in FIG. 5B.

In this retrieval process, as depicted in FIG. 6, the service component I, the service component II, and the service component III extracted by the retrieved element extracting function unit 24 are defined as nodes 52, 54, and 56 and arranged between a source node (S) 58 and a destination node (D) 59 in the order of the service components I, II, III described in the scenario. If a plurality of candidates exists, nodes 521, 522, 541, 542, 543, 561, 562, and 563 are vertically arranged by the number of candidates. A relay point node 53 is disposed between the node 52 of the service component I and the node 54 of the service component II; a relay point node 55 is disposed between the node 54 of the service component II and the node 56 of the service component III; and the relay point nodes are respectively connected. Nodes 543 and 563 of B-and-C-service components are set for a plurality of service components, and if a service component not passing through the relay point node 55 is defined by integrating the two service components, a node 57 of a B-and-C-service component is set as depicted in FIG. 7, for example. In this case, links 60, 62, 64, 66, 68, and 70 exist between the source node 58 and the destination node 59.

For one policy, for example, when cost values are defined in accordance with the policy for the link 64 and 68 connected from the relay point node 53 to the node 54 and from the relay point node 55 to the node 56 and cost values are zero for the link 62 and 66 connected from the node 52 to the relay point node 53 and from the node 54 to the relay point node 55, if it is defined in the policy that this is a free service, the links to the service components generating usage fees have greater cost values defined in proportion to the prices. If the minimum cost path is finally selected by the Dijkstra calculation, the optimum service component configuration is automatically determined in accordance with the policy.

If the free service policy is defined, although it is desirable to retrieve a configuration such that the usage fees of all the service components are zero, the usage fees may occur in some service components no matter what candidate is selected. To detect this situation, costs may be defined for the service components requiring fees for the provision as follows. In the case of a free policy, a limit of total cost is preliminarily determined for the case that only free service components are selected. The total cost is the sum of link costs making up the determined minimum cost path. A cost of a service component requiring a fee for the provision may be defined to a value greater than this upper limit. As a result, if the total cost of the minimum cost path exceeds the upper limit, it can be detected that the cost is not free although a path with the smallest fee is selected. In such a case, the definition is made in advance such that warning is generated if a total cost is greater than the upper limit so as to notify the integrated service company of the fact that a free configuration cannot be achieved, and this is notified as the warning by the integrated service deciding function unit 28.

Therefore, if a configuration does not conform to the policy although the configuration is optimum for the case of using the service components available to the integrated service company, this fact may be known by the warning before the publication and this warning may be utilized for determining whether the integrated service information is published and provided.

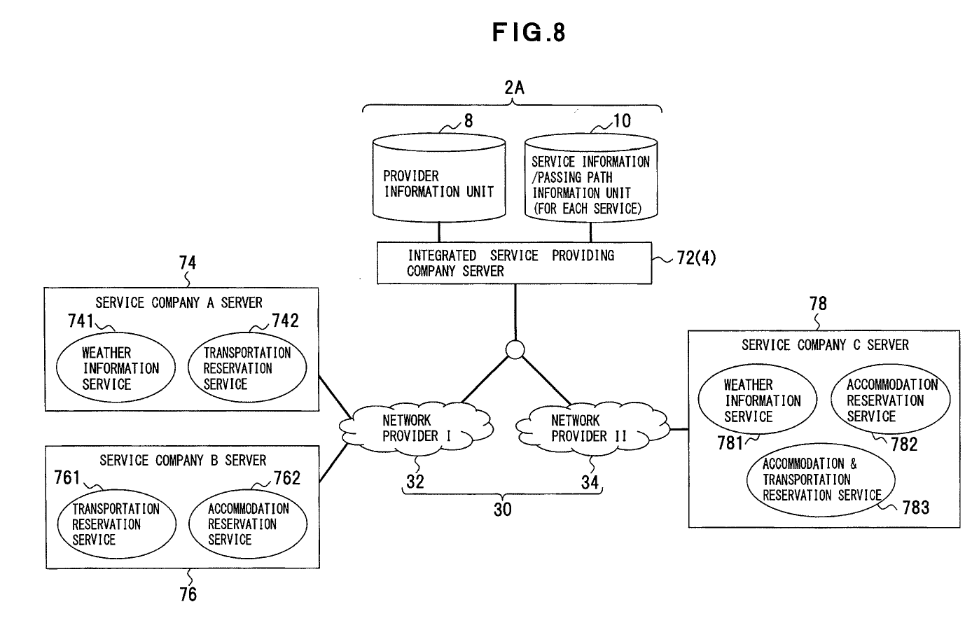

The service information published over the networks and the integration thereof will be described with reference to FIG. 8. FIG. 8 depicts a service configuration over the networks. The configuration depicted in FIG. 8 is by way of example and the present invention is not limited to this configuration. In FIG. 8, the same numerals are added to the same portions as FIG. 1.

The service information providing system 2A is made up of an integrated service providing company server 72 that is a computer system operated by an integrated service providing company. The integrated service providing company server 72 includes the integration processing unit 4. The networks 30 connected to this integrated service providing company server 72 includes the networks 32 and 34 as described in FIG. 1, and the network provider I and the network provider II exist in the network 32 and the network 34, respectively.

For example, the network provider I is connected to a service company A server 74 operated by a service company A and a service company B server 76 operated by a service company B, and the network provider II is connected to a service company C server 78 operated by a service company C. In this case, the service company A server 74 provides service components 741 and 742, and the service company B server 76 provides service components 761 and 762, and the service company C server 78 provides service components 781, 782, and 783 as the service information published over the networks 30. Specifically, the service component 741 is a weather information service; the service component 742 is a transportation reservation service; the service 761 is a transportation reservation service; the service 762 is an accommodation reservation service; the service component 781 is a weather information service; the service 782 is an accommodation reservation service; and the service 783 is an accommodation and transportation reservation service, in this example.

These service components 741, 742, 761, 762, 781, 782, and 783 are provided through the networks 32 and 34 to the integration processing unit 4 of the integrated service providing company server 72. The integration processing unit 4 uses the service components extracted based on the policy to combine the service components based on the set scenario and provides one or a plurality of pieces of integrated service information conforming to the policy and the scenario.

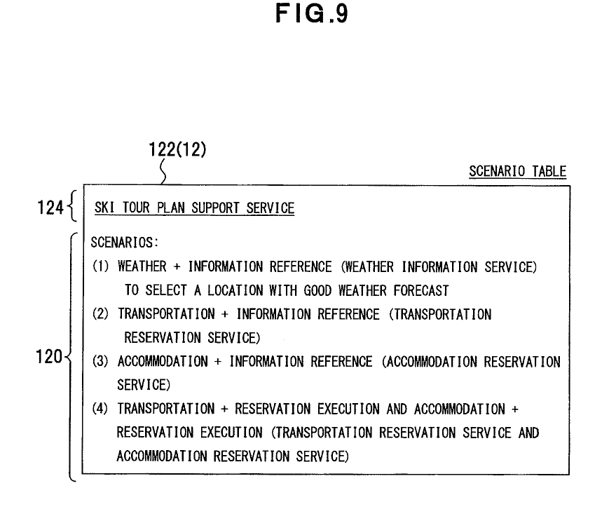

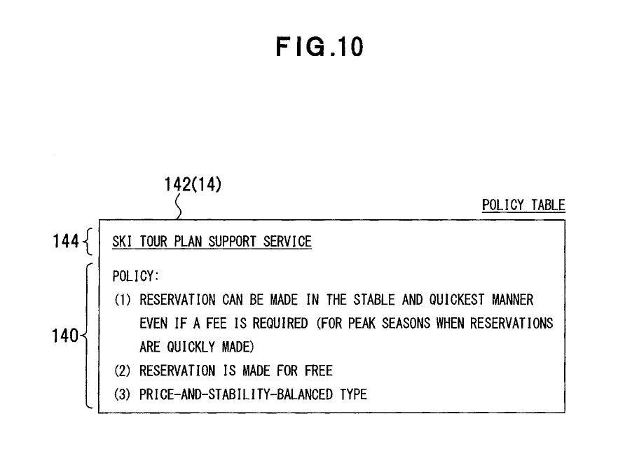

The scenarios and the policies will be described with reference to FIGS. 9 and 10. FIG. 9 depicts scenarios of ski tour plan support service information and FIG. 10 depicts a policy of ski tour plan support service information. Configurations depicted in FIGS. 9 and 10 are by way of example and the present invention is not limited to these configurations. In FIG. 9 and 10, the same numerals are added to the same portions as FIG. 1.

Scenarios 120 of the integrated service information are processed into a scenario table 122 and stored in the scenario configuring unit 12 (FIG. 1). The scenario table 122 is made up of a title 124 of the integrated service information and the scenarios 120 as depicted in FIG. 9. The title 124 is identification information that identifies the scenarios 120 used for generating a certain integrated service information and a “ski tour plan support service” in this example.

The scenarios 120 of the “ski tour plan support service” are as follows.

“Scenarios:

(1) weather+information reference (weather information service) to select a location with good weather forecast;

(2) transportation+information reference (transportation reservation service);

(3) accommodation+information reference (accommodation reservation service); and

(4) transportation+reservation execution and accommodation+reservation execution (transportation reservation service and accommodation reservation service)”

Policies 140 is processed into a policy table 142 and stored in the policy unit 14 (FIG. 1). The policy table 142 is made up of a title 144 of the integrated service information and the policy 140 as depicted in FIG. 10. The title 144 is identical to the title 124 described above.

The policies 140 of the “ski tour plan support service” are as follows.

“Policy:

(1) reservation can be made in the stable and quickest manner even if a fee is required (for peak seasons when reservations are quickly made);

(2) reservation is made for free; and

(3) price-and-stability-balanced type.

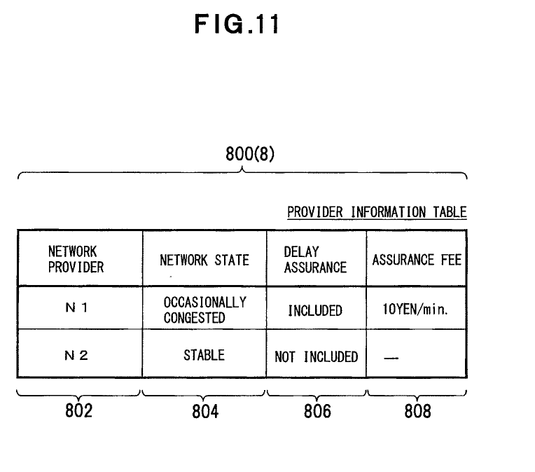

The provider information will be described with reference to FIG. 11. FIG. 11 depicts the provider information. A configuration depicted in FIG. 11 is by way of example and the present invention is not limited to this configuration. In FIG. 11, the same numerals are added to the same portions as FIG. 1.

The provider information is processed into a provider information table 800 and stored in the provider information unit 8 (FIG. 1). The provider information table 800 includes the provider information, which is information of items such as a network provider 802, a network state 804, delay assurance 806, and assurance fee 808 as depicted in FIG. 11; the network provider 802 stores identification information such as a site name; the network state 804 stores a congestion status (e.g., OCCASIONALLY CONGESTED) or a stable state (e.g., STABLE) ; the delay assurance 806 stores presence of the assurance; and the assurance fee 808 is stored as an assurance fee per unit time (one minute).

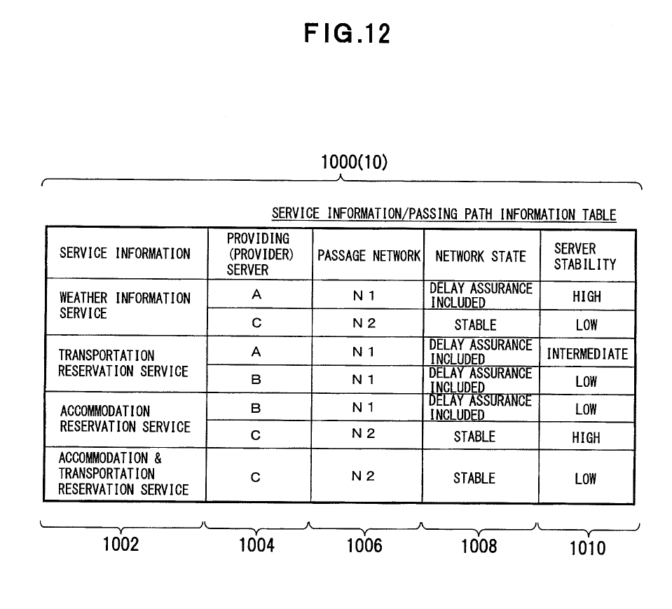

The service information/passing path information will be described with reference to FIG. 12. FIG. 12 depicts the service information/passing path information. A configuration depicted in FIG. 12 is by way of example and the present invention is not limited to this configuration. In FIG. 12, the same numerals are added to the same portions as FIG. 1.

The service information/passing path information is processed into a service information/passing path information table 1000 and stored in the service information/passing path information unit 10 (FIG. 1). The service information/passing path information table 1000 is information of items such as service information 1002, a providing (provider) server 1004, a passage network (passing path) 1006, a network state 1008, and a server stability 1010 as depicted in FIG. 12. The service information 1002 is stored as identification information such as a name identifying a service component; the providing (provider) server 1004 stores identification information representing an information source, such as a provider name or a server name; the passage network 1006 stores identification information such as a network name; the network state 1008 stores a state of a passage network such as presence of the delay assurance, stability, and instability; and the server stability 1010 stores information representing the stability of servers. In FIG. 12, N1 and N2 indicate the identification information of networks.

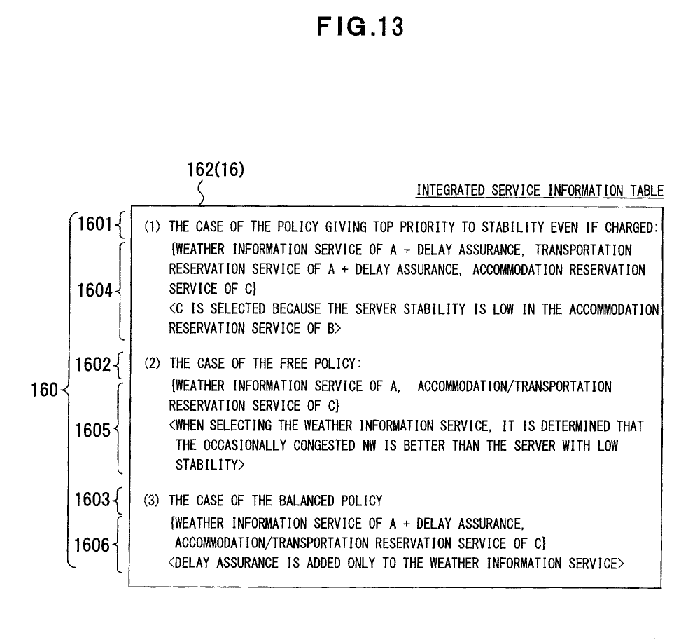

The integrated service information will be described with reference to FIG. 13. FIG. 13 depicts the integrated service information. A configuration depicted in FIG. 13 is by way of example and the present invention is not limited to this configuration. In FIG. 13, the same numerals are added to the same portions as FIG. 1.

Integrated service information 160 is processed into an integrated service information table 162 and stored in the integrated service information unit 16 (FIG. 1). The integrated service information table 162 is made up of policies 1601, 1602, 1603, integrated service element portions 1604, 1605, and 1606 as depicted in FIG. 13. The policies 1601, 1602, and 1603 correspond to the policies 140 (FIG. 10). In this case, the integrated service information 160 is as follows.

“(1) the case of the policy giving top priority to stability even if charged:

{weather information service of A+delay assurance, transportation reservation service of A+delay assurance, accommodation reservation service of C}

<C is selected because the server stability is low in the accommodation reservation service of B>;

(2) the case of the free policy:

{weather information service of A, accommodation/transportation reservation service of C}

<when selecting the weather information service, it is determined that the occasionally congested NW is better than the server with low stability>

(3) the case of the balanced policy

{weather information service of A+delay assurance, accommodation/transportation reservation service of C}

<delay assurance is added only to the weather information service>”

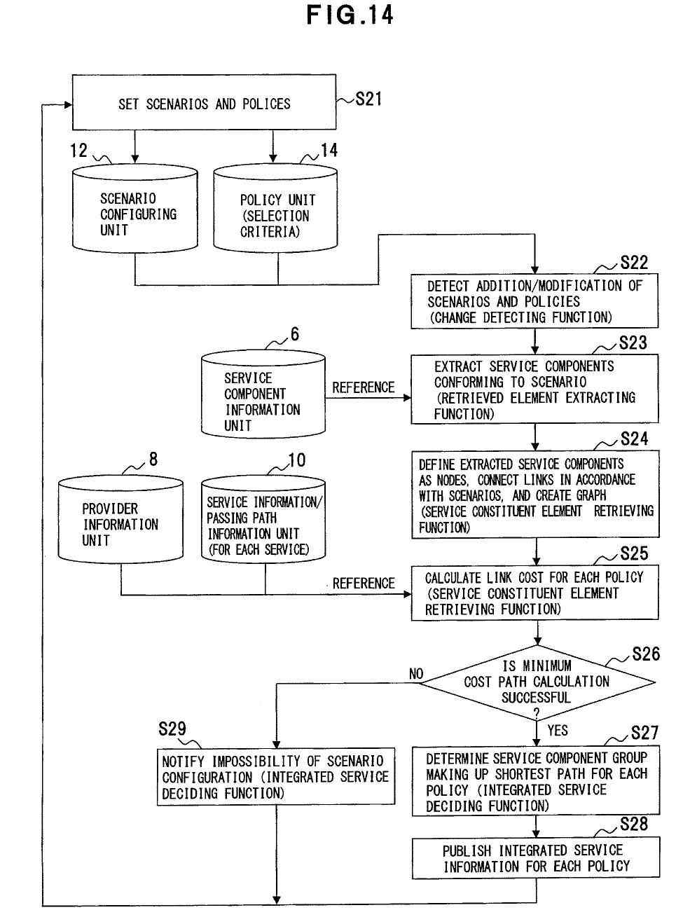

The process of the integrated service information will be described with reference to FIG. 14. FIG. 14 is a flowchart of a process procedure of the integrated service information. A configuration depicted in FIG. 14 is by way of example and the present invention is not limited to this configuration.

The process procedure of the integrated service information includes processes until the publication of the integrated service information based on the setting through descriptions of scenarios and policies. In this process procedure, as depicted in FIG. 14, the setting of scenarios and polices (step S21) is performed by an integrated service company with the integrated service providing company server 72. The scenarios are stored in the scenario configuring unit 12 and the policies are stored in the policy unit 14. The setting of scenarios and polices includes addition and modification thereof.

The setting of scenario and policy triggers the detection of addition/modification of scenarios and policies to be executed based on the change detecting function (step S22), and after the detection of changes, the service components conforming to the scenario are extracted with the reference to the service components in the service component information unit 6 based on the retrieved element extracting function (step S23). The service information published over the networks 30 is collected and stored in the service component information unit 6 and the service components are extracted from this service information.

After the service components are extracted, the extracted service components are defined as nodes and links are connected in accordance with the scenarios to create a graph based on the service constituent element retrieving function (step S24).

The creation of the graph triggers calculation of link cost for each policy with reference to the provider information in the provider information portion 8 and the service information/passing path information in the service information/passing path information unit 10, based on the service constituent element retrieving function (step S25) and it is determined from the calculation result whether the minimum cost path calculation is successful (step S26).

If the minimum cost path calculation is successful (step S26, YES), a service component group making up the shortest path is determined for each policy based on the integrated service deciding function (step S27); the integrated service information is published for each policy (step S28); a series of processes is terminated; and the procedure goes back to step S21.

If the minimum cost path calculation is not successful (step S26, NO), a notification of impossible scenario configuration is made based on the integrated service deciding function (step S29), and the procedure goes back to step S21.

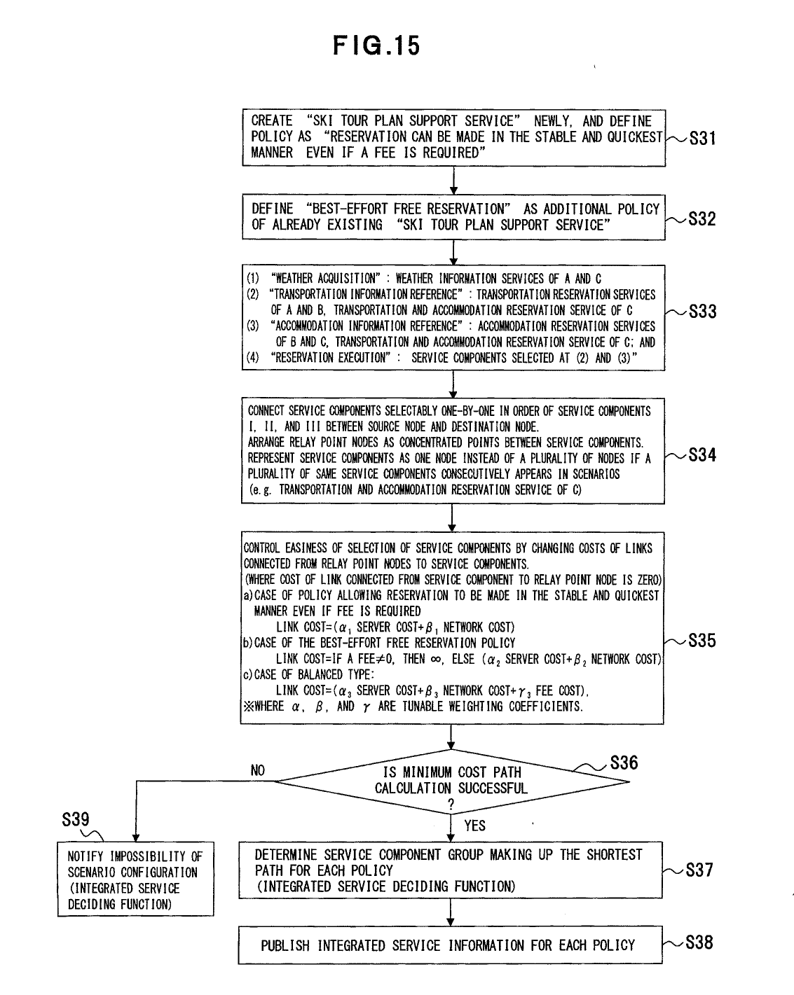

An exemplary process of the integrated service information will be described with reference to FIG. 15. FIG. 15 is a flowchart of a process procedure of the integrated service information. A configuration depicted in FIG. 15 is by way of example and the present invention is not limited to this configuration.

This process procedure is a process for the “ski tour plan support service” that is the integrated service information indicated by the scenarios described above when the policy is defined as “reservation can be made in the stable and quickest manner even if a fee is required”. The processes (steps S31 to S39) correspond to the process procedure (steps S21 to S29) of the integrated service information described above (FIG. 14).

In this process procedure, as depicted in FIG. 15, the “ski tour plan support service” is newly created and a policy is defined as “reservation can be made in the stable and quickest manner even if a fee is required” (step S31). In this case, a “best-effort free reservation” is defined as an additional policy of the already existing “ski tour plan support service” (step S32). The policy is modified by the addition. The addition of the policy is detected based on the change detecting function {step S22 (FIG. 14)}.

As depicted at step S33, these service components are listed as follows.

“(1) “weather acquisition”: weather information services of A and C;

(2) “transportation information reference”: transportation reservation services of A and B, transportation and accommodation reservation service of C;

(3) “accommodation information reference”: accommodation reservation services of B and C, transportation and accommodation reservation service of C; and

(4) “reservation execution”: service components selected at (2) and (3)”

At this step S33, the service components likely to be constituent elements of the integrated service are extracted in accordance with the scenarios by the retrieved element extracting function from the service component information (FIG. 8) published by a plurality of the service company servers 74, 76, and 78. As a result, the weather information services of the service company servers A and C are acquired for the “weather acquisition”; the transportation reservation services of A and B and the transportation and accommodation reservation service of C are acquired for the “transportation information reference”; and the accommodation reservation services of B and C and the transportation and accommodation reservation service of C are acquired for the “accommodation information reference”. For the “reservation execution”, the service components selected for both the “transportation information reference” and the “accommodation information reference” are selected.

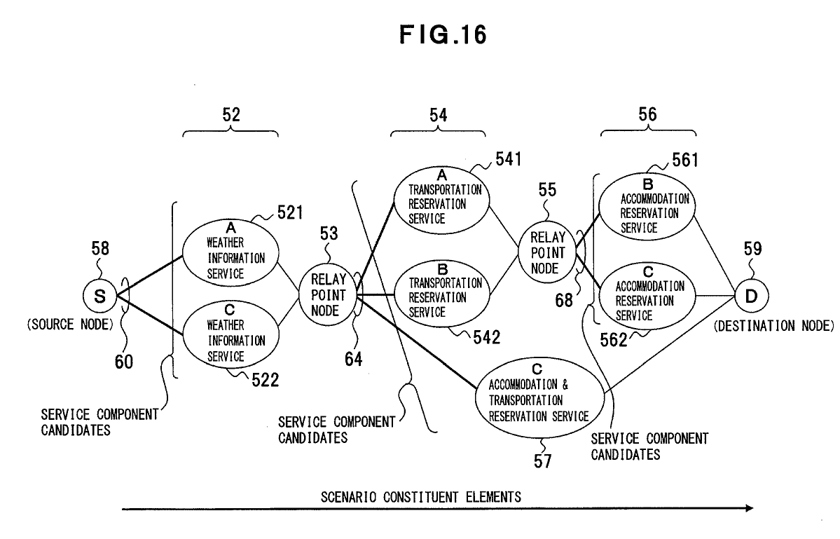

At step S34, the service components are selectably connected one-by-one in the order of the service components I, II, and III between the source node 58 (FIG. 7) and the destination node 59 (FIG. 7). Relay point nodes are arranged as concentrated points between the service components. If a plurality of the same service components consecutively appears in the scenarios, the service components are represented as one node instead of a plurality of nodes (e.g., the transportation and accommodation reservation service of C). At step S34, a service configuration (graph) depicted in FIG. 16 is created by the service constituent element retrieving function from the extracted service components.

At step S35, the selectability (easiness of selection) of the service components is controlled by changing the costs of links connected from the relay point nodes to the service components. Where costs of links connected from the service components to the relay point node is zero. The processes corresponding to these policies are listed as follows:

a) the case of the policy allowing reservation to be made in the stable and quickest manner even if a fee is required”:

link cost=(α₁ server cost+β₁ network cost);

b) the case of the best-effort free reservation policy:

link cost=if a fee≠0, then ∞, else (α₂ server cost+γ₂ network cost); and

c) the case of the balanced type:

link cost=(α₃ server cost+β₃ network cost+γ₃ fee cost)

where α, β, and γ are tunable weighting coefficients.

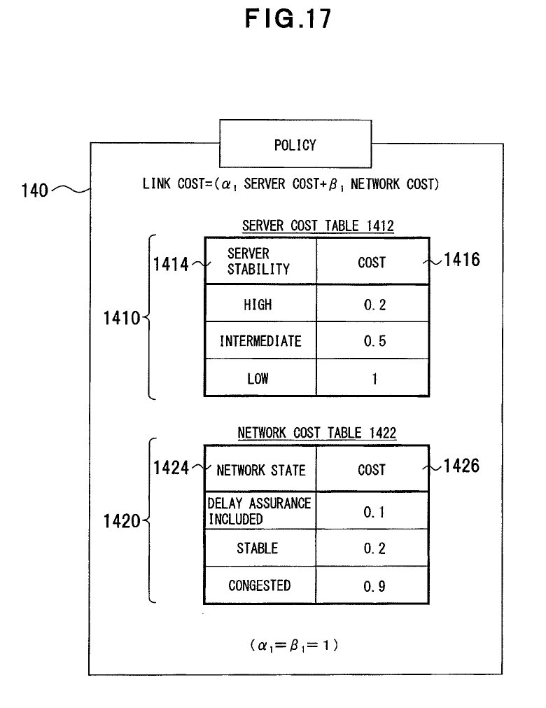

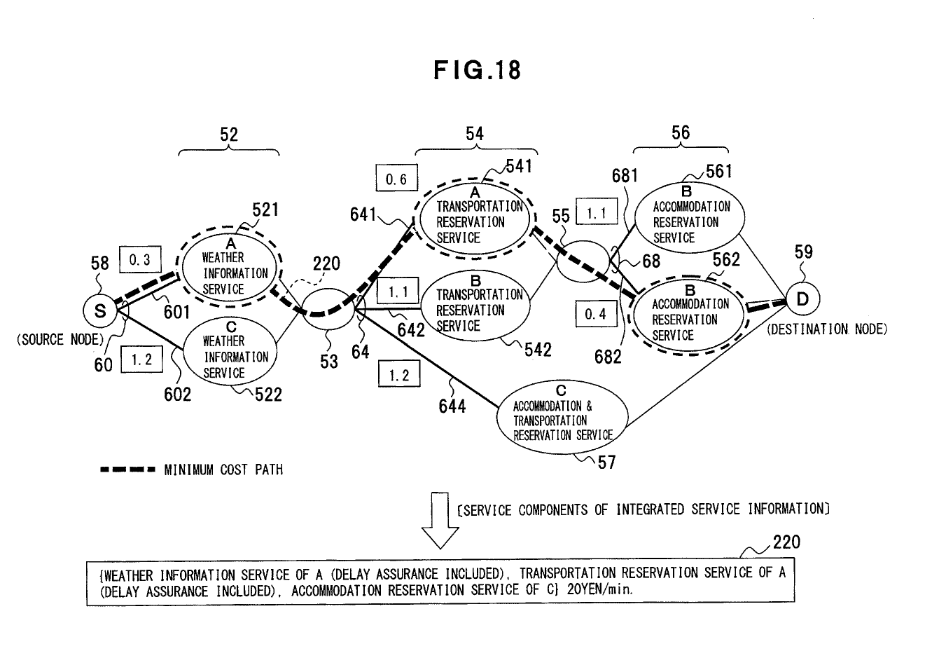

At step S35, the provider information, the service information, and the passing path information (FIGS. 11 and 12) are used to calculate the link cost of the graph for each policy by the service constituent element retrieving function. In the case of the policy “allowing reservation to be made in the stable and quickest manner even if a fee is required”, the link cost is represented by the sum of the server cost (representing the server stability) and the network cost (representing the network state) (FIGS. 17 and 18).

It is then determined whether the minimum cost path calculation is successful (step S36). At step S36, the minimum cost path from S (source node) to D (destination node) is obtained from a graph allocated with the link costs (FIG. 18) by the Dijkstra's algorithm.

If the minimum cost path calculation is successful (step S36, YES), the service component group making up the shortest path is determined for each policy based on the integrated service deciding function (step S37). At step S37, if the minimum cost path is obtained, the service components passing through the minimum cost path are decided as the constituent elements of the integrated service information based on the integrated service deciding function.

The integrated service information is published for each policy (step S38). In this case, the created integrated service information is published as the service information for the “policy allowing reservation to be made in the stable and quickest manner even if a fee is required”.

If the minimum cost path calculation is not successful (step S36, NO), a notification of impossible scenario configuration is made based on the integrated service deciding function (step S39). In this case, if the minimum cost path is not obtained, i.e., if no path exists between S (source node) and D (destination node), the integrated service deciding function makes a notification of the fact that the integrated service information cannot be configured based on the scenarios.

The service configuration will be described with reference to FIG. 16. FIG. 16 depicts the service configuration. The configuration depicted in FIG. 16 is by way of example and the present invention is not limited to this configuration. In FIG. 16, the same numerals are added to the same portions as FIG. 7.

In this service configuration, as depicted in FIG. 16, the scenario constituent elements generate the transition from the source node 58 to the destination node 59; the service component I, the service component II, and the service component III are defined as the node 52, 54, and 56 and arranged between the source node 58 and the destination node 59 in the order of the service components I, II, III described in the scenario; and if a plurality of candidates exists, the nodes 521, 522, 541, 542, 561, and 562 are vertically arranged by the number of candidates. The relay point node 53 is disposed between the node 52 of the service component I and the node 54 of the service component II; the relay point node 55 is disposed between the node 54 of the service component II and the node 56 of the service component III; and the relay point nodes are respectively connected. If a service component may implement a plurality of service components and is consecutively used, the node 57 of the B-and-C-service component is set as a service component not passing through the relay point node 55. In this case, the links 60, 62, 64, 66, 68, and 70 exist between the source node 58 and the destination node 59.

With regard to the nodes 521, 522, 541, 542, 561, 562, and 57 as each service component, the node 521 denotes the weather information service of the service company server A; the node 522 denotes the weather information service of C; the node 541 denotes the transportation reservation service of A; the node 542 denotes the transportation reservation service of B; the node 561 denotes the accommodation reservation service of B; the node 562 denotes the accommodation reservation service of C; and the node 57 denotes the transportation and accommodation reservation service of C.

The policy and the service configuration will be described with reference to FIGS. 17 and 18. FIG. 17 depicts a policy and FIG. 18 depicts a service configuration. The configurations of FIGS. 17 and 18 are by way of example and the present invention is not limited to these configurations. In FIGS. 17 and 18, the same numerals are added to the same portions as FIG. 16.

The link cost is given as “link cost=(α₁ server cost+β₁ network cost)” as depicted in FIG. 17. A policy 140 in this case is to give top priority to stability even if charged and is made up of a server cost 1410 and a network cost 1420. The server cost 1410 is processed into a server cost table 1412 and stored in the policy unit 14, and the network cost 1420 is processed into a network cost table 1422 and stored in the policy unit 14. The server cost 1410 is made up of server stability 1411 and cost 1416; the server stability 1411 has “high”, “intermediate”, or “low” set to indicate a level of stability; and cost values are set for the cost 1416. The network cost 1420 is made up of a network state 1424 and a cost 1426; the network state 1424 has, for example, “delay assurance included” or “delay assurance not included” set as information indicative of whether the delay assurance is included, has, for example, “stable” or “unstable” set as information indicative of stability, and has “congested” or “vacant” set as information indicative of usage status; and cost values are set for the cost 1426. In the above equation, α₁=β₁=1 is assumed.

In this service configuration, as depicted in FIG. 18, a link cost of a link 601 from the source node 58 to the service component node 521 is 0.3, for example; a link cost of a link 602 from the source node 58 to the service component node 522 is 1.2, for example; a link cost of a link 641 from the relay point node 53 to the node 541 is 0.6, for example; a link cost of a link 642 from the relay point node 53 to the node 542 is 1.1, for example; a link cost of a link 644 from the relay point node 53 to the node 57 is 1.2, for example; a link cost of a link 681 from the relay point node 55 to the node 561 is 1.1, for example; and a link cost of a link 682 from the relay point node 55 to the node 562 is 0.4, for example. In this case, since the weather information service of A is “delay assurance included” and the transportation reservation service of A is “delay assurance included”, a minimum cost path 220 is made up of a low-link-cost path, which is the source node 58—the link 601—the node 521—the link 641—the node 541—the link 682—the node 562—the destination node 59, as indicated by a dash line of FIG. 18, and the fee thereof is, for example, 20 yen/min. This is the link cost of the integrated service information consisting of a combination of the service components conforming to one policy 140.

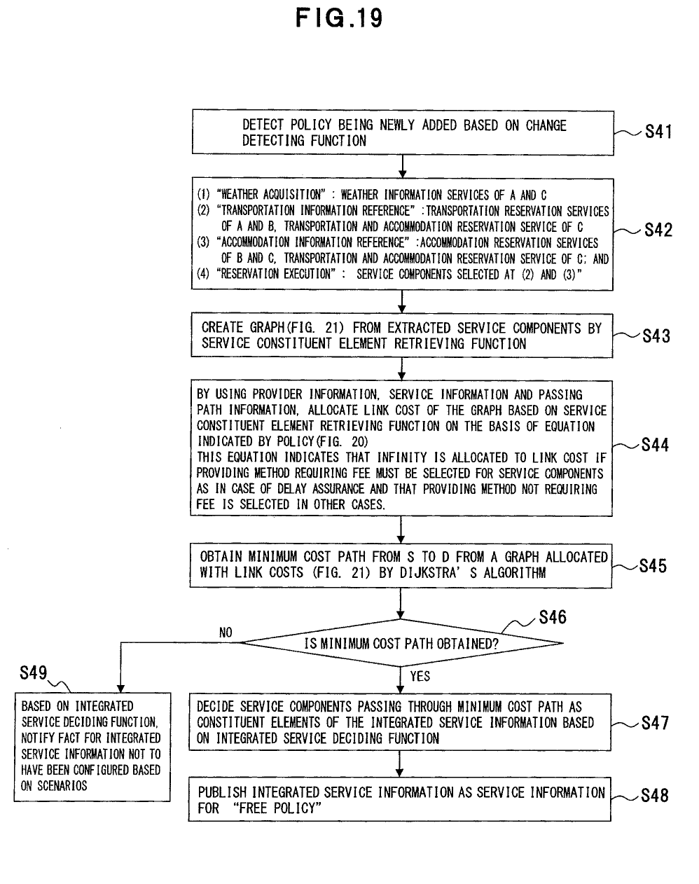

An integrating process due to addition of a policy will be described with reference to FIG. 19. FIG. 19 is a flowchart of a process procedure of an integrating process due to addition of a policy. A configuration of FIG. 19 is by way of example and the present invention is not limited to this configuration.

This process procedure is a process when the “free policy” is added to the current policy 140. Therefore, in this process procedure, as depicted in FIG. 19, it is detected based on the change detecting function that a policy is newly added (step S41). As a result, the “free policy” is added, which is an additional policy.

At step S42, the service components likely to be constituent elements of the integrated service are extracted in accordance with the scenarios by the retrieved element extracting function from the service component information (FIG. 8) published by a plurality of the service company servers 74, 76, and 78. As a result, the weather information services of the service company servers A and C are acquired for the “weather acquisition”; the transportation reservation services of A and B and the transportation and accommodation reservation service of C are acquired for the “transportation information reference”; and the accommodation reservation services of B and C and the transportation and accommodation reservation service of C are acquired for the “accommodation information reference”. For the “reservation execution”, the service components selected for both the “transportation information reference” and the “accommodation information reference” are selected.

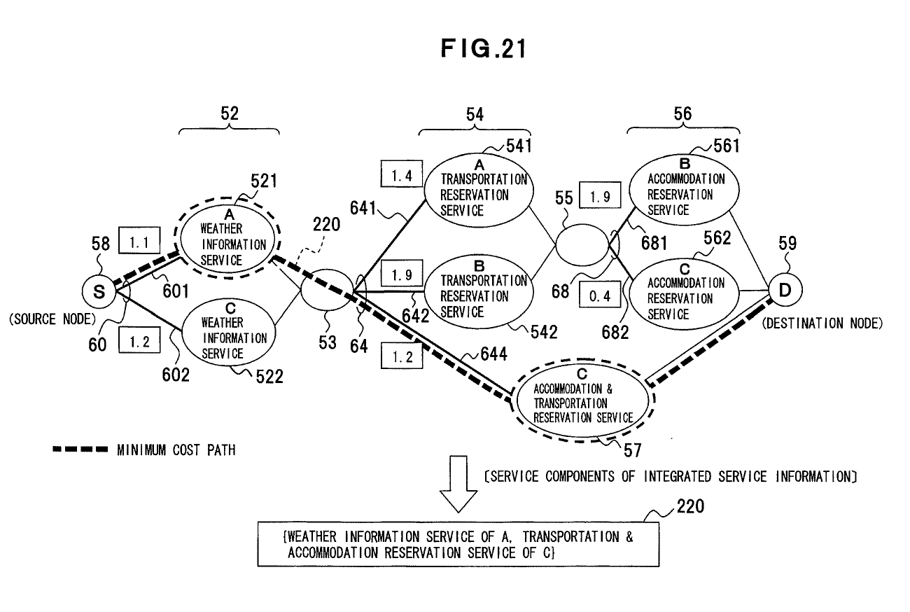

At step S43, a service configuration (graph) depicted in FIG. 21 is created by the service constituent element retrieving function from the extracted service components.

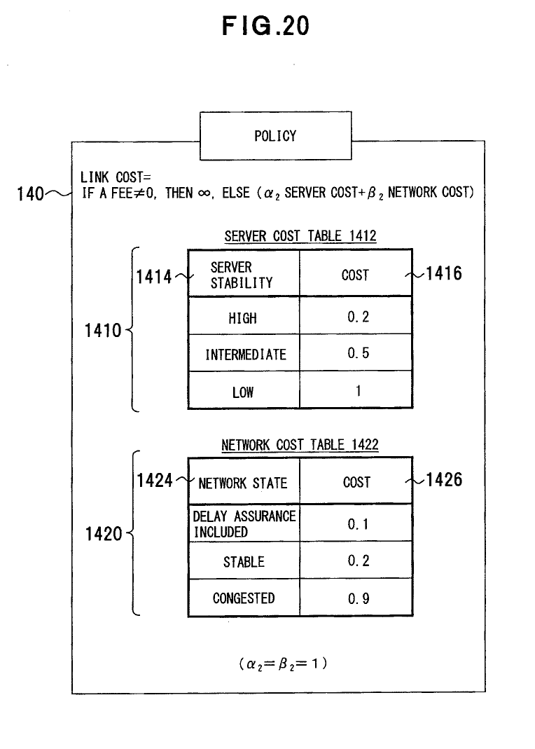

At step S44, the provider information, the service information, and the passing path information (FIGS. 11 and 12) are used to allocate the link cost of the graph based on the service constituent element retrieving function on the basis of the equation indicated by the policy (FIG. 20). This equation indicates that the infinity is allocated to the link cost if a providing method requiring the fee must be selected for the service components as in the case of the delay assurance and that a providing method not requiring the fee is selected in other cases.

The minimum cost path from S (source node) to D (destination node) is obtained from a graph allocated with the link costs (FIG. 21) by the Dijkstra's algorithm (step S45).

It is determined whether the minimum cost path is obtained (step S46), and if the minimum cost path is obtained (step S46, YES), the service components passing through the minimum cost path are decided as the constituent elements of the integrated service information based on the integrated service deciding function (step S47). This integrated service information is published as the service information for the “free policy” (step S48).

If the minimum cost path is not obtained, i.e., if no path exists between the source node 58 and the destination node 59 (step S46, NO), the integrated service deciding function makes a notification of the fact that the integrated service information cannot be configured based on the scenarios (step S49).

The policy and the service configuration will be described with reference to FIGS. 20 and 21. FIG. 20 depicts a policy and FIG. 21 depicts a service configuration. The configurations of FIGS. 20 and 21 are by way of example and the present invention is not limited to these configurations. In FIGS. 20 and 21, the same numerals are added to the same portions as FIGS. 17 and 18.

The link cost is given as “link cost=if a fee≠0, then ∞, else (α₂ server cost+β₂ network cost)” as depicted in the policy 140 of FIG. 20. In this equation, α₂=β₂=1 is assumed. Other constituent elements are the same as those of FIG. 17, therefore, are given the same numerals, and will not be described.

In this service configuration, as depicted in FIG. 21, a link cost of the link 601 from the source node 58 to the service component node 521 is 1.1, for example; a link cost of the link 602 from the source node 58 to the service component node 522 is 1.2, for example; a link cost of the link 641 from the relay point node 53 to the node 541 is 1.4, for example; a link cost of the link 642 from the relay point node 53 to the node 542 is 1.9, for example; a link cost of the link 644 from the relay point node 53 to the node 57 is 1.2, for example; a link cost of the link 681 from the relay point node 55 to the node 561 is 1.9, for example; and a link cost of the link 682 from the relay point node 55 to the node 562 is 0.4, for example.

The minimum cost path 220 is made up of a low-link-cost path, which is the source node 58—the link 601—the node 521—the link 644—the node 57—the destination node 59, as indicated by a dash line of FIG. 21. The integrated service information is made up of the weather information service of A and the transportation and accommodation reservation service of C due to the minimum cost path 220 at the basis of “free policy”.

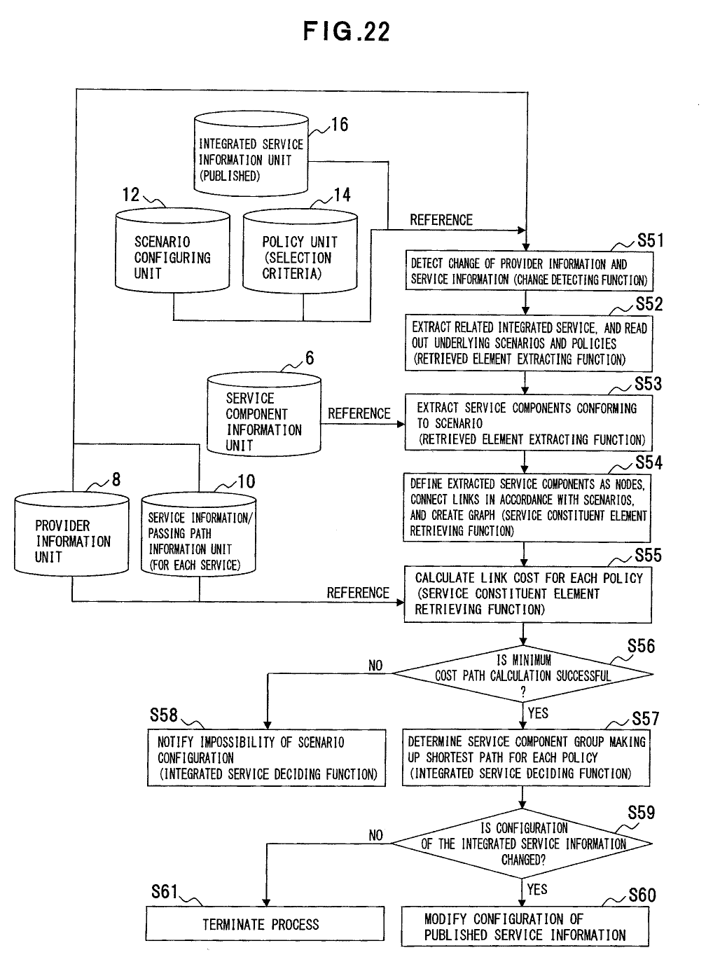

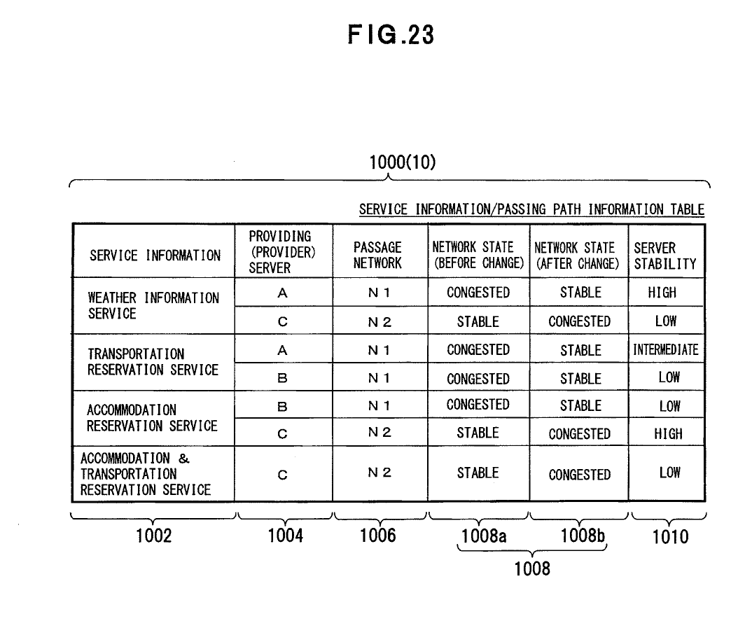

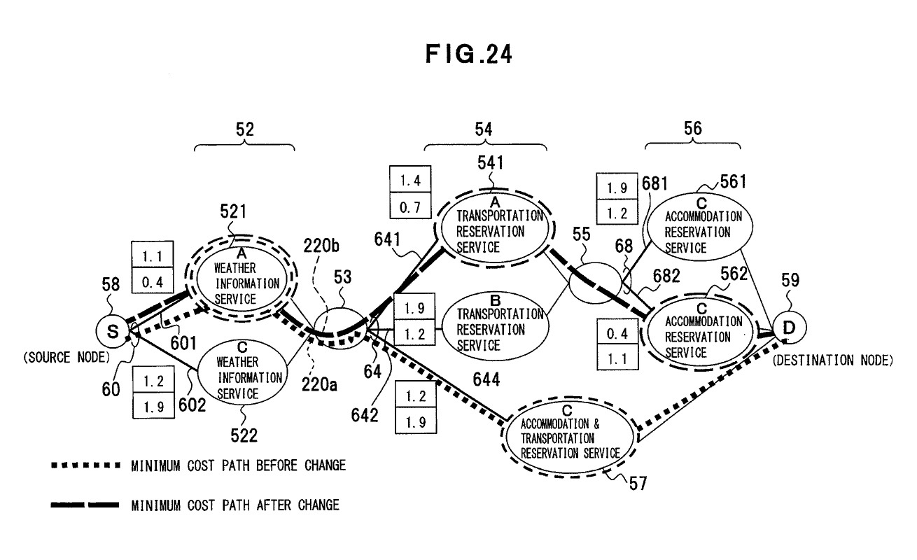

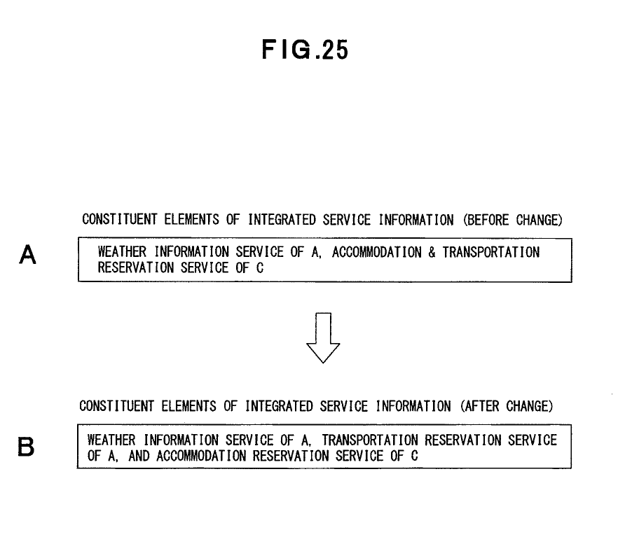

Dynamic modification of scenarios will be described with reference to FIGS. 22, 23, 24, and 25. FIG. 22 is a flowchart of a process procedure of dynamic modification of scenarios; FIG. 23 depicts the service information/passing path information; FIG. 24 depicts the service configuration; and FIG. 25 depicts a change in the integrated service information. The configurations of FIGS. 22 to 25 are by way of example and the present invention is not limited to these configurations. In FIGS. 23 and 24, the same numerals are added to the same portions as FIGS. 12 and 21.

This process procedure is a process of dynamic modification corresponding to a change in the state of the network 30 when the integrated service information of the above “free policy” is published, and this process procedure is a process of detecting that the service information/passing path information is changed with the change detecting function to reconfigure and publish the integrated service information.

In this process procedure, the change detecting function is executed to make a reference to the provider information unit 8, the service information/passing path information unit 10, the scenario configuring unit 12, the policy unit 14, and the integrated service information unit 16, and a change in the state of the network 30 is detected by monitoring the provider information from the provider information unit 8 and the service information/passing path information from the service information/passing path information unit 10 (step S51). For example, in such a case that the state of the network provider I is changed from the congested state to the stable state and that the state of the network provider II is changed from the stable state to the congested state, these changes in the states are detected.

By executing the retrieved element extracting function, the integrated service information related to the state changes is extracted from the integrated service information unit 16 and the underlying scenarios and policies are read (step S52) to calculate the minimum cost path based on the information after the changes (step S53, S54, and S55). The retrieved element extracting function is executed to make a reference to the service component information in the service component information unit 6 to extract the service components conforming to the scenarios (step S53); the service constituent element retrieving function is executed to define the extracted service components as nodes and the links are connected in accordance with the scenarios to create a graph (step S54); and the service constituent element retrieving function is executed to calculate a link cost for each policy and the minimum cost path is calculated (step S55). For the process at step S55, a reference is made to the provider information in the provider information unit 8 and the service information/passing path information in the service information/passing path information unit 10.

It is determined whether the minimum cost path calculation is successful (step S56), and if the minimum cost path calculation is successful (step S56, YES), a service component group making up the shortest path is determined for each policy based on the integrated service deciding function (step S57). If the minimum cost path calculation is not successful (step S56, NO), a notification of impossible scenario configuration is made based on the integrated service deciding function (step S58).

After the service component group is determined, it is determined whether the configuration of the integrated service information is changed (step S59), and if the configuration is changed (step S59, YES), the configuration of the published service is modified, and the integrated service information with the modified configuration is published (step S60).

If the configuration of the integrated service information is not changed (step S59, NO), this process is terminated based on the integrated service deciding function (step S61).

In this dynamic modification process, the changing network states for the service information/passing path information is processed into a service information/passing path information table 1000 as depicted in FIG. 23 and stored in the service information/passing path information unit 10 (FIG. 1). In this case, network states 1008 are made up of a network state 1008a before the change and a network state 1008b after the change and the states before and after the change are stored for each piece of the service information and each network. Other constituent elements are the same as those of the service information/passing path information table 1000 (FIG. 12), therefore, are given the same numerals, and description thereof is omitted. The numeric values and states exemplarily depicted are by way of example and are varied due to network states, etc.

In the service configuration in this case, as depicted in FIG. 24, a link cost of the link 601 from the source node 58 to the service component node 521 is changed from 1.1 to 0.4; a link cost of the link 602 from the source node 58 to the service component node 522 is changed from 1.2 to 1.9; a link cost of the link 641 from the relay point node 53 to the node 541 is changed from 1.4 to 0.7; a link cost of the link 642 from the relay point node 53 to the node 542 is changed from 1.9 to 1.2; a link cost of the link 644 from the relay point node 53 to the node 57 is changed from 1.2 to 1.9; a link cost of the link 681 from the relay point node 55 to the node 561 is changed from 1.9 to 1.2; and a link cost of the link 682 from the relay point node 55 to the node 562 is changed from 0.4 to 1.1.

In such a service configuration, a minimum cost path 220b after the change is made up of a lower-link-cost path, which is the source node 58—the link 601—the node 521—the link 641—the node 541—the link 682—the node 562—the destination node 59, as compared to a minimum cost path 220a before the change (the source node 58—the link 601—the node 521—the link 644—the node 57—the destination node 59).

As a result, the constituent elements (service components) of the integrated service information are the weather information service of A and the accommodation and transportation reservation service of C before the change as depicted by A of FIG. 25 and are modified to the weather information service of A, the transportation reservation service of A, and the accommodation reservation service of C after the change as depicted by B of FIG. 25. The constituent elements of the integrated service information are modified by the change in the policy 140 and is updated to and published as the modified integrated service information.

With regard to the reconfiguration and publication of the integrated service information based on the change detecting function described above, the configuration of the integrated service information may be prevented from being frequently modified due to small changes by converting the changes into, for example, numeric values and setting a threshold value for determination of whether the reconfiguration is performed. With such a configuration, the stabilization of the integrated service information is achieved.

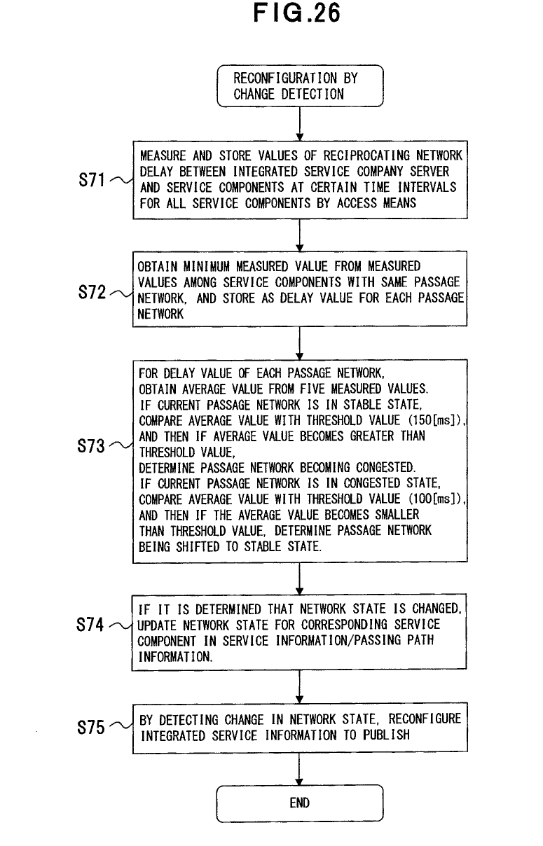

A change in the network state will be described with reference to FIG. 26. FIG. 26 is a flowchart of a process procedure of detection of a change in the network state. A configuration depicted in FIG. 26 is by way of example and the present invention is not limited to this configuration.

This process procedure is a process of detecting that the network state is changed from the stable state to the congested state (or from the congested state to the stable state), and the service component providing server/passage network examining function unit 20 is assumed to have, for example, the following information for the change detection conditions in advance. In this case, with regard to the reciprocating network delay between the integrated service company server service components, a first threshold value is set to 150 [ms] for determining that the network state is changed from the stable state to the congested state and a second threshold value is set to 100 [ms] for determining that the network state is changed from the congested state to the stable state as the condition. These values are by way of example and the present invention is not limited to these values.

In this process procedure, as depicted in FIG. 26, the reciprocating network delay between the integrated service company server service components is measured at certain time intervals for all the service components by an access means based on the service providing server/passage network examining function, and the measured values are stored (step S71).

For the passage networks and the service components, the minimum measured value is obtained from the measured values among the service components with the same passage network and is stored as a delay value for each passage network (step S72).

An average of a plurality of previously measured values is obtained for the delay value of each passage network. For example, an average value is obtained from five measured values. If the current passage network is in the stable state, the average value is compared with the threshold value (150 [ms]) and if the average value becomes greater than the threshold value, it is determined that the passage network becomes congested. If the current passage network is in the congested state, the average value is compared with the threshold value (100 [ms]) and if the average value becomes smaller than the threshold value, it is determined that the passage network is shifted to the stable state (step S73).

If it is determined that the network state is changed, the network state is updated for the corresponding service component in the service information/passing path information (step S74).

The change in the network state is detected by reference to the service information/passing path information based on the change detecting function to reconfigure the integrated service information, and after the reconfiguring process, the integrated service information is published (step S75). The current integrated service information is updated by the reconfiguring process.

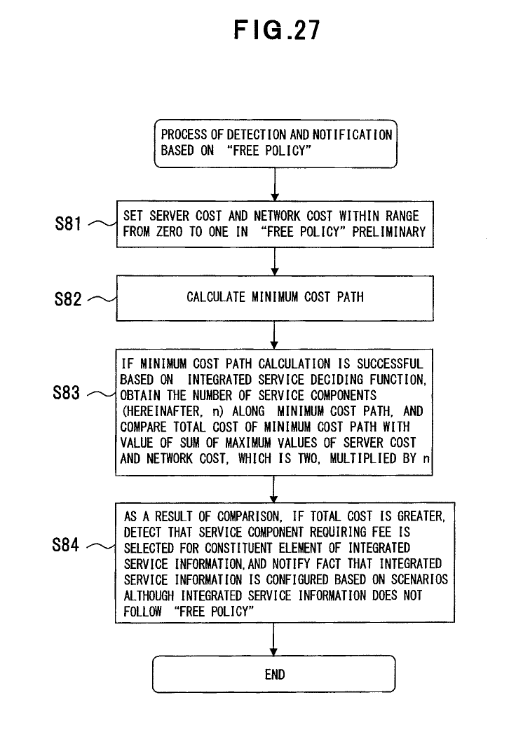

The process of the integrated service information will be described with reference to FIG. 27. FIG. 27 is a flowchart of a process procedure of the integrated service information. A configuration depicted in FIG. 27 is by way of example and the present invention is not limited to this configuration.

This process procedure of the integrated service information includes processes of detection and notification thereof based on the “free policy” since fees of the selected constituent elements are high.

In this process procedure, as depicted in FIG. 27, for example, the server cost and the network cost are set within a range from zero to one as indices based on the “free policy” in the setting of the “free policy” (step S81).

Based on this setting, the minimum cost path is obtained (step S82). The calculation of the minimum cost path may be executed based on above steps S52 to S55 (FIG. 22).

After the calculation of the minimum cost path, if the minimum cost path calculation is successful based on the integrated service deciding function, the number of service components (hereinafter, n) along the minimum cost path is obtained, and the total cost of the minimum cost path is compared with a value of the sum of the maximum values of the server cost and the network cost, which is two, multiplied by n (step S83).

As a result of the comparison, if the total cost is greater, it is detected that the service component requiring the fee is selected for the constituent element of the integrated service information, the integrated service company is notified of the fact that the integrated service information is configured based on the scenarios although the integrated service information does not follow the “free policy” (step S84).

With above process, if the integrated service information does not conform to the policy in such a case that the total cost is greater based on the calculation of the minimum cost path, the notification of this fact may be made by the notification function included in the integrated service deciding function, and the notified user (company) may perform recalculation, etc.

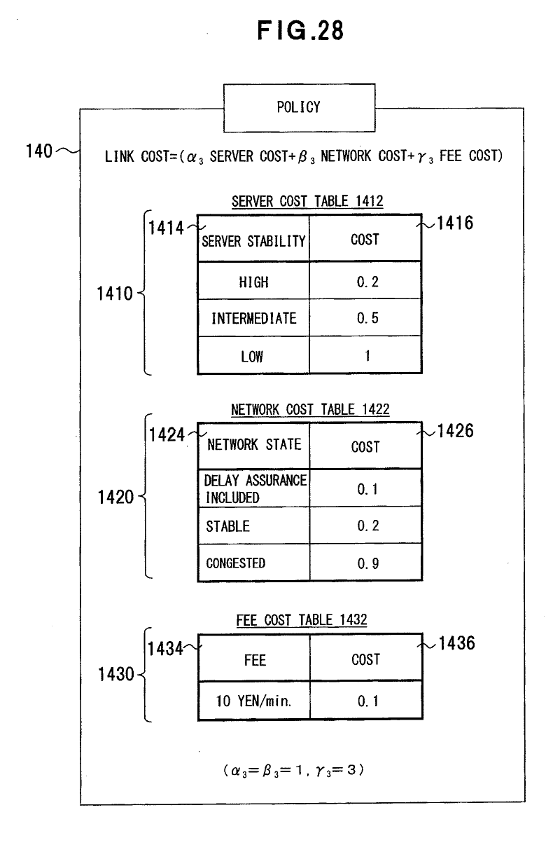

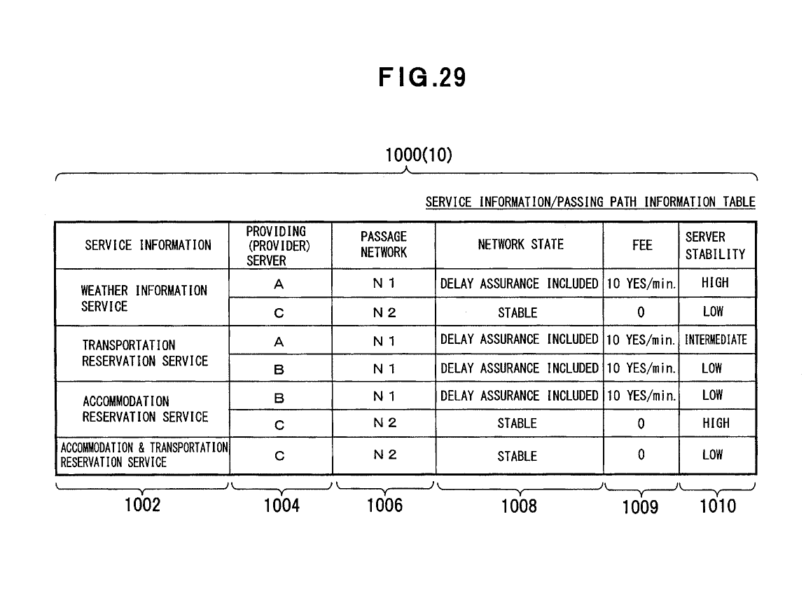

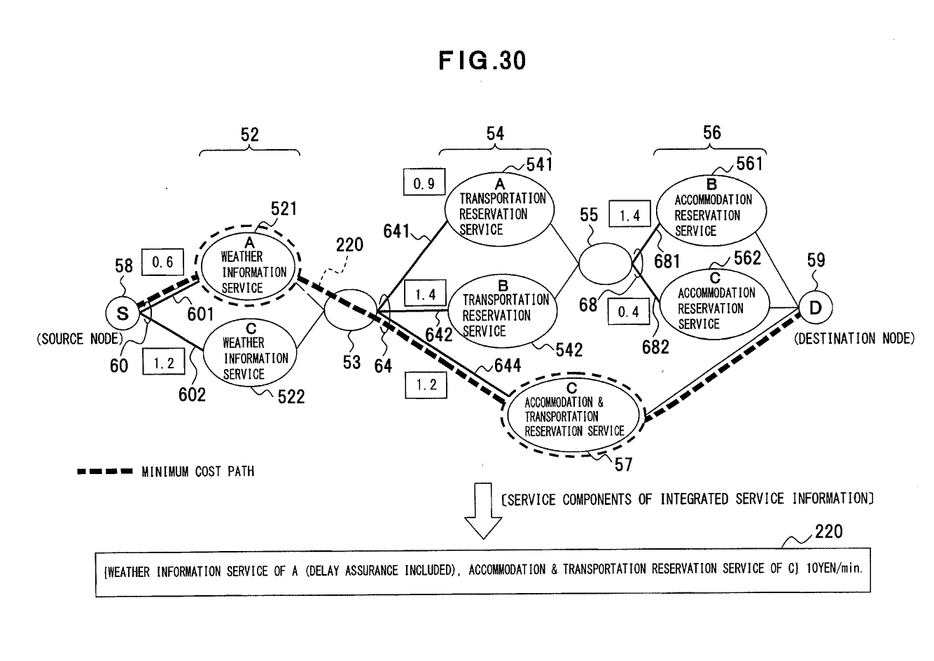

Another policy and a service configuration will be described with reference to FIGS. 28, 29, and 30. FIG. 28 depicts a policy; FIG. 29 depicts the service information/passing path information; and FIG. 30 depicts a service configuration. The configurations depicted in FIGS. 28, 29, and 30 are by way of example and the present invention is not limited to these configurations. In FIGS. 28 to 30, the same numerals are added to the same portions as FIGS. 12, 17, 20, 21, 23, or 24.

This integrated service information conforms to the balanced-type policy for price and stability. Therefore, the link cost is given as “link cost=(α₃ server cost+β₃ network cost+γ₃ fee cost)” as depicted in the policy 140 of FIG. 28. In this equation, α₂=β₂=1 and γ₃=3 are assumed.

The link cost is obtained as the sum of the server cost, the network cost, and the fee cost. Therefore, in the policy 140, a fee cost 1430 is processed into and stored to a fee cost table 1432 in addition to the server cost table 1412 and the network cost table 1422 described above (FIG. 17), and a fee 1434 is set to, for example, “10 yen/min” and a cost 1436 is set to, for example, “0.1” in the fee cost table 1432.

In this case, the providing servers, the passage networks, the network states, the fees, and the server stability corresponding to each service component are processed into the service information/passing path information table 1000 as depicted in FIG. 29 and stored in the service information/passing path information unit 10 (FIG. 1) as the service information/passing path information. In this case, a fee 1009 is set and stores fee for each service component. Specific numeric values are by way of example and the present invention is not limited to these numeric values.

In the service configuration in this case, as depicted in FIG. 30, a link cost of the link 601 from the source node 58 to the service component node 521 is 0.6; a link cost of the link 602 from the source node 58 to the service component node 522 is 1.2; a link cost of the link 641 from the relay point node 53 to the node 541 is 0.9; a link cost of the link 642 from the relay point node 53 to the node 542 is 1.4; a link cost of the link 644 from the relay point node 53 to the node 57 is 1.2; a link cost of the link 681 from the relay point node 55 to the node 561 is 1.4; and a link cost of the link 682 from the relay point node 55 to the node 562 is 0.4.

In such a service configuration, the minimum cost path 220 is made up of a low-link-cost path, which is the source node 58—the link 601—the node 521—the link 644—the node 57—the destination node 59, and this is the integrated service information.

This integrated service information is made up of the weather information service of A (delay assurance included) and the accommodation and transportation reservation service of C and is provided at a fee of 10 yen/min, which is the minimum cost.

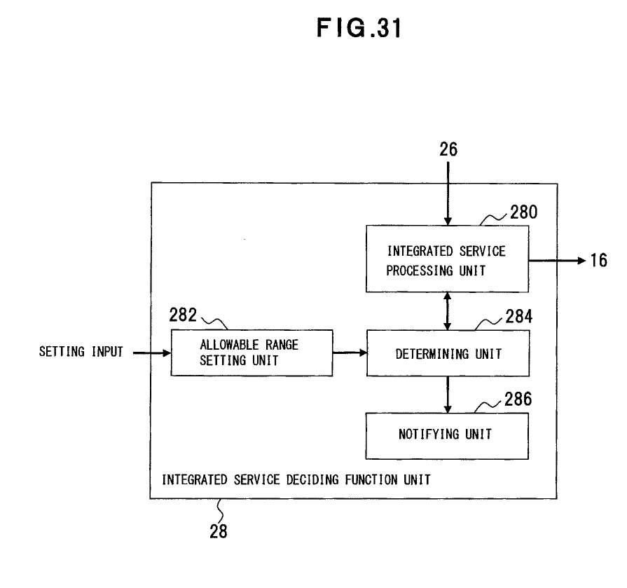

An exemplary configuration of the integrated service deciding function unit 28 will be described with reference to FIG. 31. The integrated service deciding function unit 28 may be configured to have a function of determining whether the integrated service information is configured within an allowable range and may include an integrated service processing unit 280, an allowable range setting unit 282, a determining unit 284, and a notifying unit 286 as depicted in FIG. 31. Such a configuration may be configured as hardware or may be configured as software. The integrated service processing unit 280 is a deciding means for the integrated service information made up of the service components conforming to the policies and combinations of the service components in accordance with the scenarios; the allowable range setting unit 282 is a means of numerically deciding an allowable range for the optimum configuration in advance; and the determining unit 284 is a means of determining whether the configuration of the integrated service information finally determined by the integrated service processing unit 280 falls within the allowable range set by the allowable range setting unit 282. If the final configuration of the integrated service information deviates from the allowable range as a result of the determination, the notifying unit 286 makes a notification. The notifying unit 286 is a warning means. The allowable range is determined in accordance with the policies and the scenarios and is specifically represented by numeric values indicative of whether free or paid, whether stabilized or not, a retrieval rate, whether a network state is good, etc.

With such a configuration, the process of selecting or prioritizing the integrated service information may be executed for the integrated service information configured by the integrated service processing unit 280 based on different policies and scenarios serving as the setting input of externally or internal set allowable ranges of the allowable range setting unit 282 to publish information suitable for various criteria such as information providers, users, or timings.

Features and effects of the first embodiment described above will hereinafter be listed.

(1) A method and a system of generating the integrated information based on policies may be implemented as described above.

(2) As above, the service information providing system 2A has a configuration including a function unit that collects service information published by a plurality of service companies (public service information collecting/managing function), a function unit that collects network information and server information related to the service companies (service providing server/passage network examining function), a retrieved target extracting unit that extracts available service component candidates from the collected service information based on descriptions in scenarios (retrieved element extracting function), a retrieving function unit that determines a combination of a suitable service components in accordance with descriptions in scenarios such that the combination conforms to the own defined policies of the integrated service company and such that the service may optimally be provided using the collected service information and service information (service configuration element retrieving function), and an integrated service deciding function unit that decides the publication of the integrated service based on the retrieved result (integrated service deciding function).

(3) With regard to the configuration modification due to additions and changes of scenarios and policies, a change detecting function is included to enable detection of the changes in scenarios and the additions and changes of policies, redetermination of a combination of suitable service components, and modification of the scenarios of the published service.

(4) With regard to the configuration modification due to changes in conditions of networks and services, a change detecting function is included to enable detection of changes in networks and service information, redetermination of a combination of suitable service components, and modification of the scenarios of the published service.

(5) With regard to the notification when the optimum configuration may not be achieved, a means is included to preliminarily and numerically determine an allowable range of the optimum configuration, and a means is included to notify of the fact that a determined configuration is not so preferable if the finally determined configuration of the optimum integrated service information does not fall within the range of the numeric values (integrated service deciding function).

(6) Although the provision of the integrated service information is affected by environmental variations such as networks and servers of companies providing service components and evaluations from users, these variations may rapidly be reflected to generate and publish useful integrated service.

(7) When a plurality of company servers provides service components having the same function, it may easily be determined from which company server a service component should be selected.

(8) Even when qualities are varied in networks and servers of the company servers providing service components, the integrated service conforming to the policies may be provided.

(9) For one piece of the integrated service components, a variation made up of different service components may be created for each policy, and a user may select a service for the desired policy.

(10) The integrated service company server may rapidly publish new integrated service information only by adding and modifying scenarios and policies and may rapidly modify configurations of published integrated service information.

(11) If environmental information such as status of the service providing server or network is varied from the time point when the integrated service information is configured, scenarios created for respective policies may rapidly be modified to optimum configurations to publish and provide the latest integrated service information.

(12) The integrated service company server may detect nonconformity to a policy even when available service components are used to form an optimum configuration and may provide the optimum integrated service information by determining before publication whether the integrated service information is provided.

### Second Embodiment

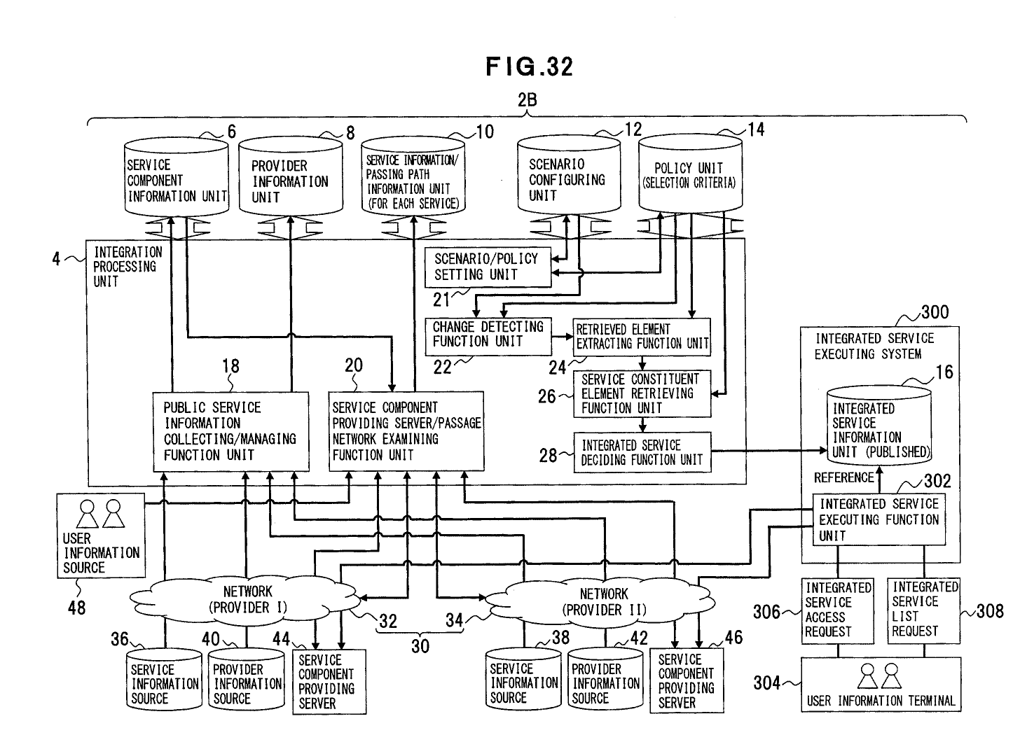

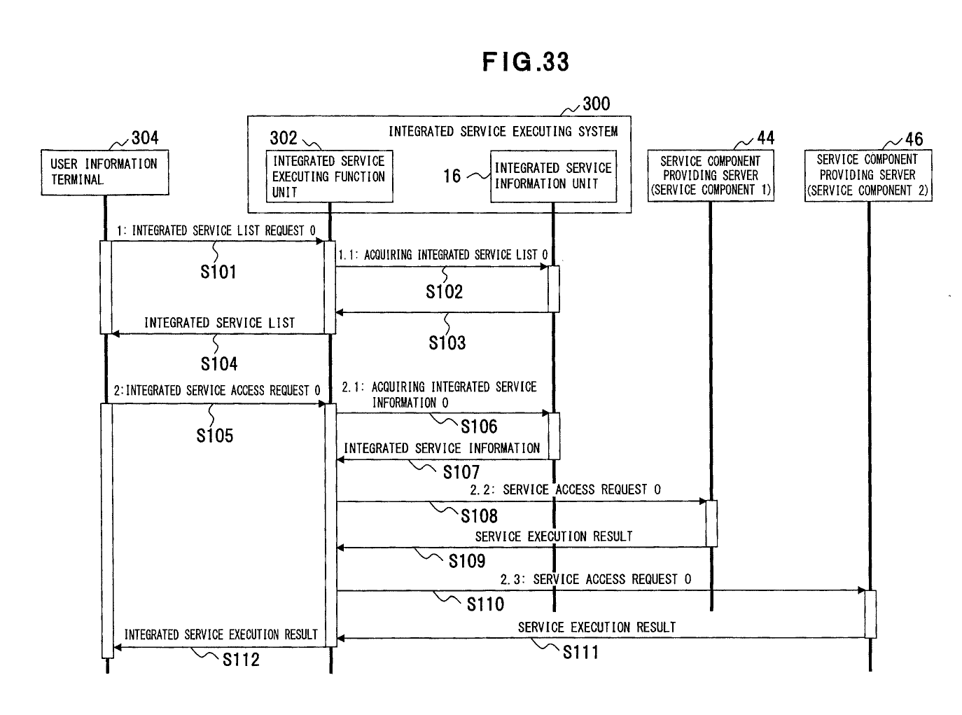

A second embodiment will be described with reference to FIGS. 32 and 33. FIG. 32 depicts a service information providing system according to the second embodiment and FIG. 33 depicts an access sequence of the integrated service information. The configurations depicted in FIGS. 32 and 33 are by way of example and the present invention is not limited to these configurations. In FIGS. 32 and 33, the same numerals are added to the same portions as FIG. 1.

A service information providing system 2B is the above service information providing system 2A (FIG. 1) including an integrated service executing system 300. The integrated service executing system 300 is an integrated service information utilizing system for users. As depicted in FIG. 32, an integrated service information unit 16 is disposed and an integrated service executing function unit 302 is included. Since the portions of the service information providing system 2B in common with the above service information providing system 2A have the same configurations and functions, the portions are given the same numerals as the above service information providing system 2A and will not be described.

The integrated service executing function unit 302 is an executing means that provides the integrated service information in the integrated service information unit 16 based on requests and accesses the integrated service information unit 16 to acquire and provide the integrated service information depending on requests corresponding to an integrated service access request 306 or an integrated service list request 308 from a user information terminal 304 for the integrated service information.

Referring to the sequence depicted in FIG. 33 with regard to the access of the integrated service executing system 300, the integrated service list request 308 is issued from the user information terminal 304 (step S101), and the integrated service executing function unit 302 receives the integrated service list request 308 and executes a process of acquiring an integrated service list from the integrated service information unit 16 (step S102). The integrated service list is transmitted to the integrated service executing function unit 302 of the integrated service executing system 300 (step S103) and is provided from the integrated service executing function unit 302 to the user information terminal 304 (step S104).

The user information terminal 304 refers to the integrated service list to issue the integrated service access request 306 (step S105). The integrated service executing function unit 302 receives the integrated service access request 306 and executes a process of acquiring the integrated service information from the integrated service information unit 16 (step S106) and the integrated service information is correspondingly provided from the integrated service information unit 16 to the integrated service executing function unit 302 (step S107).

In this case, the integrated service information includes a service component 1 and a service component 2 as constituent elements. The service component 1 and the service component 2 are service components provided from the service component providing servers 44 and 46, respectively.

Therefore, a service access request is issued from the integrated service executing function unit 302 through the network 32 to the service component providing server 44 (step S108), and the service component providing servers 44 receives this request and supplies the service execution result to the integrated service executing function unit 302 (step S109).

A service access request is also issued from the integrated service executing function unit 302 through the network 34 to the service component providing server 46 (step S110), and the service component providing servers 46 receives this request and supplies the service execution result to the integrated service executing function unit 302 (step Sill).

The integrated service executing function unit 302 provides the service execution result to the user information terminal 304 (step S112) to complete the integrated service information providing process.

With such a configuration, the service information providing system 2B provides the integrated service information integrated in accordance with a scenario using the service components 1 and 2 selected by a certain policy through the access from the user information terminal 304.

Since the second embodiment includes the features and the function described in the first embodiment, the same effects as the first embodiment may be acquired.

### Third Embodiment

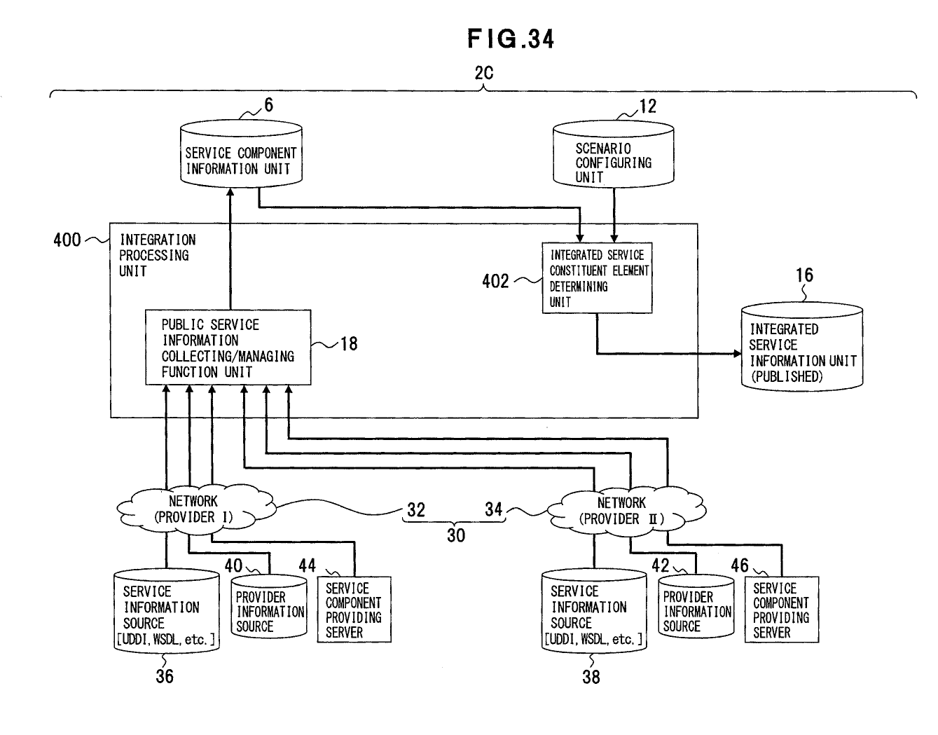

A third embodiment will be described with reference to FIG. 34. FIG. 34 depicts a service information providing system according to the third embodiment. The configuration depicted in FIG. 34 is by way of example and the present invention is not limited to this configuration. In FIG. 34, the same numerals are added to the same portions as FIG. 1.

A service information providing system 2C is triggered by the setting of scenario to extract service components used for the scenario from service information or service components and uses the service components to generate integrated service information. In this case, an integration processing unit 400 includes the public service information collecting/managing function unit 18 and an integrated service constituent element determining unit 402. The service component information unit 6, the scenario configuring unit 12, and the public service information collecting/managing function unit 18 are the same as above and will not be described.

For example, the service components such as web services are published over the networks 30. For example, the services are published by a service provider connected to the network provider I or a service provider connected to the network provider II. Registration to UDDI (Universal Description, Discovery and Integration) may be used as a method of publishing web services to enable retrieval of the service components and the service information. Interface information necessary for utilizing the services may be described in a standard description language, WSDL (Web Services Description Language).

For the integrated service information, the public service information collecting/managing function is used to collect and manage the service components and the service information, and the integrated service constituent element determining function is used to create a scenario for the integrated service information that is a combination of a plurality of service components and to define whether the service components are utilized as available elements for the scenario.

The integrated service information is configured by combining the service components with the service configuration defined in accordance with the described scenario. This integrated service information is published through the integrated service information unit 16.

The integrated service constituent element determining unit 402 extracts and combines the service components in the service component information unit 6 in accordance with the scenario set in the scenario configuring unit 12, stores the integrated service information acquired as a result into the integrated service information unit 16 for publication over the networks 30. The setting of the scenario may trigger the combination of available service components to configure and publish the integrated service information as above.

Although the service components are not selected with policies in this embodiment unlike the first or second embodiment, the setting of the scenario may trigger the configuration of the integrated service information without relation to the policies and various types of the integrated service information may be implemented depending on the scenario.

### Fourth Embodiment

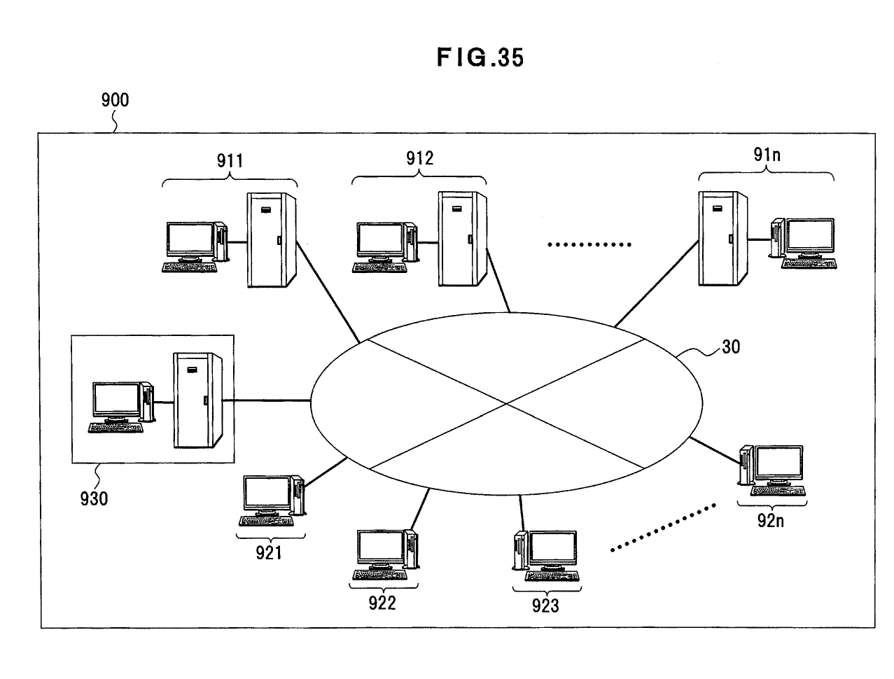

A fourth embodiment will be described with reference to FIG. 35. FIG. 35 depicts a network system according to the fourth embodiment. The configuration depicted in FIG. 35 is by way of example and the present invention is not limited to this configuration. In FIG. 35, the same numerals are added to the same portions as FIGS. 1, 32, or 34.

A network system 900 includes a plurality of service component providing servers 911, 912 . . . 91n connected to the network 30, various published service components, and user information terminals 921, 922 . . . 92n connected as clients and, under the environment provided with the service components, the network 30 is connected to a service information providing server 930 equipped with the service information providing system 2B, for example.

In the network system 900 as above, the above integration process may be used to generate the integrated service information for each policy with the service components selected by the policy and combined by a scenario for the service information providing server 930.

Therefore, the user information terminals 921, 922 . . . 92n may access the service information providing server 930 through the network 30 and may be provided with the integrated service information conforming to a desired policy.

### Fifth Embodiment

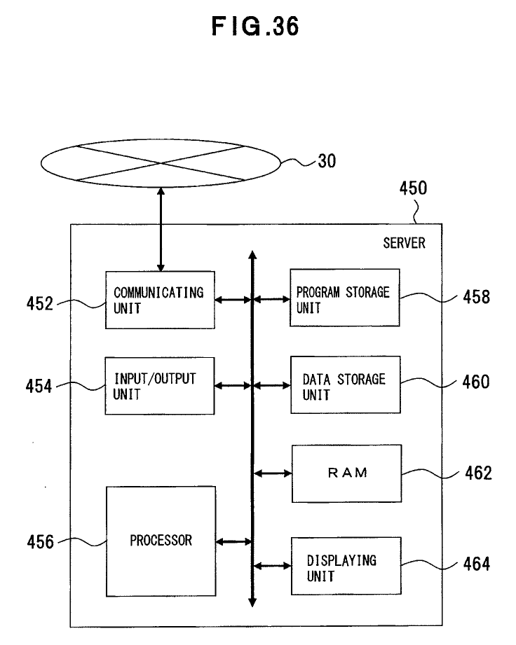

A fifth embodiment will be described with reference to FIG. 36. FIG. 36 depicts a server used for a service information providing system according to a fifth embodiment. The configuration depicted in FIG. 36 is by way of example and the present invention is not limited to this configuration. In FIG. 36, the same numerals are added to the same portions as FIG. 1, 32, or 34.

This server 450 is a means serving as the integration processing unit 4, the service component information unit 6, the provider information unit 8, the service information/passing path information unit 10, the scenario configuring unit 12, the policy unit 14, and the integrated service information unit 16 and makes up the integrated service providing company server 72, etc. The server 450 includes a communicating unit 452, an input/output unit 454, a processor 456, a program storage unit 458, a data storage unit 460, a RAM 462, and a displaying unit 464 as depicted in FIG. 36.

The communicating unit 452 is a communicating means that transmits and receives information through communications with other servers over the network 30 and is controlled by the processor 456. The input/output unit 454 is an information input/output means and is used for input of scenarios and policies, for example.

The processor 456 is a means of executing OS (Operating System) and application programs such as an integrated service information processing program in the program storage unit 458 and is made up of a CPU (Central Processing Unit) to control various function units, collect the service components, extract the service components in accordance with policies, combine the service components in accordance with scenarios, and execute various processes such as the service component integrating process.

The program storage unit 458 is a storage means having stored thereon the OS and the integrated service information processing program and is made up of a recording medium. The data storage unit 460 is a recording medium serving as the provider information unit 8, the service information/passing path information unit 10, the scenario configuring unit 12, the policy unit 14, and the integrated service information unit 16. The RAM 462 makes up a work area. The displaying unit 464 is a means of presenting information and a user interface for display such as an external display device.

With such a configuration, various servers may be configured as above to construct the above service information providing system 2A, 2B, or 2C.

Matters Extracted from the Embodiments

The service information providing apparatus includes the following variations. In the service information providing apparatus, preferably, the scenario and a policy for the service components may be set to the generating part, and the generating part may generate the integrated service information based on the scenario by selecting service components conforming to the policy. With such a configuration, the integrated service information is generated with the use of different parameters, which are the scenario and the policy; the integrated service information conforming to the scenario may be generated with the service components conforming to the policy; the policies such as convenience and stability may be reflected to the integrated service information; and highly-convenient and highly-stable service information may be provided.

Preferably, the service information providing apparatus may include an integrated service information publishing part that publishes the integrated service information over the network, wherein the integrated service information generated by the generating part may be published by the integrated service information publishing part over the network.

Preferably, the service information providing apparatus may include an information collecting part that collects information concerning the network and/or a publishing source publishing the service information, wherein the generating part may use the publishing source information and/or the network information to control the integrated service information.

Preferably, the service information providing apparatus may include a change detecting part that detects a change in the scenario, wherein the generating part may enable the scenario of the integrated service information to be modified based on the detection result of the change detecting part.

Preferably, the service information providing apparatus may include a change detecting part that detects a change in the policy, wherein the generating part may enable a combination of the service components of the integrated service information to be modified based on the detection result of the change detecting part.

Preferably, the service information providing apparatus may include a change detecting part that detects a change in the network and/or a change in the service information, wherein the generating part may enable a combination of the service components to be modified based on the detection result of the change detecting part.

Preferably, the service information providing apparatus may include a setting part that sets an allowable range for the integrated service information; a determining part that determines whether the integrated service information generated by the generating part is adapted to the allowable range; and a notifying part that notifies of the determination result of the determining part if it is determined that the integrated service information is not adapted to the allowable range.

The service information providing method includes the following variations. Preferably, the service information providing method may further include setting the scenario and a policy for the service components and generating the integrated service information based on the scenario by selecting service components conforming to the policy.

Preferably, the service information providing method may further include publishing the generated integrated service information over the network.

Preferably, the service information providing method may further include collecting information concerning the network and/or a publishing source publishing the service information; and using the publishing source information and/or the network information to control the integrated service information.

Preferably, the service information providing method may further include detecting a change in the scenario; and modifying the scenario of the integrated service information based on the detection result of the change in the scenario.

Preferably, the service information providing method may further include detecting a change in the policy; and modifying a combination of the service components of the integrated service information based on the detection result of the change in the policy.

Preferably, the service information providing method may further include detecting a change in the network and/or a change in the service information; and modifying a combination of the service components based on the detection result of the change in the network and/or the change in the service information.

Preferably, the service information providing method may further include setting an allowable range for the integrated service information; determining whether the integrated service information is adapted to the allowable range; and notifying of the determination result if it is determined that the integrated service information is not adapted to the allowable range.

According to an aspect of the embodiments, there is provided a computer-readable recording medium storing a service information providing program executable by a computer, the program includes the steps of collecting service information and/or service components provided over a network; extracting service components to be used for a set scenario from the service information or the service components based on the scenario; and generating integrated service information based on the scenario with the use of the service components extracted at the above step.

Preferably, the service information providing program may further include the step of setting the scenario and a policy for the service components and generating the integrated service information based on the scenario by selecting service components conforming to the policy.

Preferably, the service information providing program may further include the step of publishing the generated integrated service information over the network.

Preferably, the service information providing program may further include the steps of collecting information concerning the network and/or a publishing source publishing the service information; and using the publishing source information and/or the network information to control the integrated service information.

Preferably, the service information providing program may further include the steps of detecting a change in the scenario; and modifying the scenario of the integrated service information based on the detection result of the change in the scenario.

Preferably, the service information providing program may further include the steps of detecting a change in the policy; and modifying a combination of the service components of the integrated service information based on the detection result of the change in the policy.

Preferably, the service information providing program may further include the steps of detecting a change in the network and/or a change in the service information; and modifying a combination of the service components based on the detection result of the change in the network and/or the change in the service information.

Preferably, the service information providing program may further include the steps of setting an allowable range for the integrated service information; determining whether the integrated service information is adapted to the allowable range; and notifying of the determination result if it is determined that the integrated service information is not adapted to the allowable range.

Features and advantages of the embodiments are listed as follows.

(1) Service information and/or service components provided over a network may be collected and setting of a scenario may trigger extraction of service components used for the scenario from the service information or the service components to generate integrated service information with the use of the service components based on the scenario, and the integrated service information may be provided as high-quality service information that is highly convenient and stable.

(2) If a policy is set separately from the scenario, the integrated service information based on the scenario may be generated with the user of service components selected by the policy to create a variation of the integrated service information with the policy. The published integrated service information may be selected depending on policies.

(3) The integrated service information may rapidly be modified and regenerated depending on modifications such as additions of the scenario and/or the policy, and the highly-convenient and stable integrated service information may be generated and provided.

(4) The scenario and/or the policy may be modified correspondingly to changes in the service environment such as service providing servers and networks, and the integrated service information may rapidly be modified into the optimum configuration depending on the modifications

(5) If the integrated service information using available service components based on the scenario does not conform to the set policy, the nonconformity may be checked and known before the publication of the integrated service information to prevent the publication of the integrated service information not conforming to the policy. The integrated service information not conforming to the policy may be corrected before the publication to provide the optimum integrated service information conforming to the policy.

The present embodiments may collect service information and/or service components provided over a network, may be triggered by setting of a scenario to extract service components used for the scenario from the service information or the service components to generate integrated service information with the use of the service components based on the scenario, and is useful since convenience of utilization may be improved in the service information provided over networks in such a way that the integrated service information may be provided as high-quality service information that is highly convenient and stable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A service information providing apparatus comprising:
a collecting part that collects service information and/or service components provided over a network;
an extracting part that extracts service components to be used for a set scenario from the service information or the service components based on the scenario; and
a generating part that generates integrated service information based on the scenario with the use of the service components extracted by the extracting part.

2. The service information providing apparatus of claim 1, wherein the scenario and a policy for the service components are set to the generating part, and the generating part generates the integrated service information based on the scenario by selecting service components conforming to the policy.

3. The service information providing apparatus of claim 1, comprising:
an integrated service information publishing part that publishes the integrated service information over the network, wherein the integrated service information generated by the generating part is published by the integrated service information publishing part over the network.

4. The service information providing apparatus of claim 1, comprising:
an information collecting part that collects information concerning the network and/or a publishing source publishing the service information, wherein the generating part uses the publishing source information and/or the network information to control the integrated service information.

5. The service information providing apparatus of claim 1, comprising:
a change detecting part that detects a change in the scenario, wherein the generating part enables the scenario of the integrated service information to be modified based on the detection result of the change detecting part.

6. The service information providing apparatus of claim 2, comprising:
a change detecting part that detects a change in the policy, wherein the generating part enables a combination of the service components of the integrated service information to be modified based on the detection result of the change detecting part.

7. The service information providing apparatus of claim 4, comprising:
a change detecting part that detects a change in the network and/or a change in the service information, wherein the generating part enables a combination of the service components to be modified based on the detection result of the change detecting part.

8. The service information providing apparatus of claim 1, comprising:
a setting part that sets an allowable range for the integrated service information;
a determining part that determines whether the integrated service information generated by the generating part is adapted to the allowable range; and
a notifying part that notifies of the determination result of the determining part if it is determined that the integrated service information is not adapted to the allowable range.

9. A service information providing method comprising:
collecting service information and/or service components provided over a network;
extracting service components to be used for a set scenario from the service information or the service components based on the scenario; and
generating integrated service information based on the scenario with the use of the service components extracted at the above extracting.

10. The service information providing method of claim 9, further comprising setting the scenario and a policy for the service components and generating the integrated service information based on the scenario by selecting service components conforming to the policy.

11. The service information providing method of claim 9, further comprising publishing the generated integrated service information over the network.

12. The service information providing method of claim 9, further comprising:
collecting information concerning the network and/or a publishing source publishing the service information; and
using the publishing source information and/or the network information to control the integrated service information.

13. The service information providing method of claim 9, further comprising:
detecting a change in the scenario; and
modifying the scenario of the integrated service information based on the detection result of the change in the scenario.

14. The service information providing method of claim 10, further comprising:
detecting a change in the policy; and
modifying a combination of the service components of the integrated service information based on the detection result of the change in the policy.

15. The service information providing method of claim 12, further comprising:
detecting a change in the network and/or a change in the service information; and
modifying a combination of the service components based on the detection result of the change in the network and/or the change in the service information.

16. The service information providing method of claim 9, further comprising:
setting an allowable range for the integrated service information;
determining whether the integrated service information is adapted to the allowable range; and
notifying of the determination result if it is determined that the integrated service information is not adapted to the allowable range.
